(19) United States
(12) Patent Application Publication
(10) Pub. No.: US 2026/0179998 A1
(43) Pub. Date: Jun. 25, 2026

(54) STACK DEVICE

(71) Applicant: Top Engineering Co., Ltd., Gumi-si, Gyeongsangbuk-do (KR)

(72) Inventors: Min Hyung LEE, Gumi-si, Gyeongsangbuk-do (KR); Jea Young PARK, Gumi-si, Gyeongsangbuk-do (KR); Kum Ho KOOK, Gumi-si, Gyeongsangbuk-do (KR); Kyoung Dong KIM, Gumi-si, Gyeongsangbuk-do (KR); Byong Ki KIM, Gumi-si, Gyeongsangbuk-do (KR); Seung Hyun LEE, Gumi-si, Gyeongsangbuk-do (KR); Sang Jin BAE, Gumi-si, Gyeongsangbuk-do (KR); No Hyeon PARK, Gumi-si, Gyeongsangbuk-do (KR)

(73) Assignee: Top Engineering Co., Ltd., Gumi-si, Gyeongsangbuk-do (KR)

(21) Appl. No.: 19/125,764

(22) PCT Filed: Nov. 3, 2023
(86) PCT No.: PCT/KR2023/017575

§ 371 Date: Apr. 30, 2025

(30) Foreign Application Priority Data
Nov. 3, 2022 (KR) 10-2022-0145611
Nov. 3, 2022 (KR) 10-2022-0145614
Nov. 3, 2022 (KR) 10-2022-0145619
Nov. 3, 2022 (KR) 10-2022-0145620
Nov. 3, 2022 (KR) 10-2022-0145621
Nov. 3, 2022 (KR) 10-2022-0145625

(51) Int. Cl. H01M 10/04

(52) U.S. Cl. CPC H01M 10/0409; H01M 10/0431

(57) ABSTRACT

An embodiment discloses a stacking apparatus including a stacking module including a main stage, and a stacking head configured to stack a positive electrode plate, a negative electrode plate, and a separator on the main stage, a positive electrode plate supply module configured to supply the positive electrode plate, and a negative electrode plate supply module configured to supply the negative electrode plate, in which the positive electrode plate supply module and the negative electrode plate supply module each include an accommodation unit configured to accommodate an electrode plate that is any one of a plurality of positive electrode plates or a plurality of negative electrode plates, and a pick-up unit configured to pick up the electrode plate accommodated in the accommodation unit, and in which the pick-up unit includes a plurality of first sucking parts configured to suck the electrode plate, a body part configured to support the plurality of first sucking parts, and a vibration part configured to shake the picked-up electrode plate.

### TECHNICAL FIELD

Embodiments relate to a stacking apparatus for manufacturing electrode assemblies.

### BACKGROUND ART

Recently, secondary batteries have been applied to various technical fields throughout industries. The secondary batteries also have attracted attention as energy sources for hybrid electric vehicles and the like that have been proposed to solve problems of air pollution caused by gasoline and diesel internal combustion engines in the related art.

A stacking apparatus manufactures the secondary battery by stacking positive electrode plates, separators, and negative electrode plates. However, the stacking apparatus in the related art has many problems, as follows.

Because the stacking apparatus in the related art has a structure in which a stage alternately stacks the positive electrode plates and the negative electrode plates while moving leftward and rightward, there is a problem in that a space in which the stage moves leftward and rightward is required, which increases a size of the stacking apparatus.

In addition, two electrode plates are picked up in a state in which the electrode plates are attached to each other by static electricity, which may cause defective processes and products.

In addition, there is a problem in that it is difficult to maintain the tension of the separators during the process in which the stacking apparatus stacks the positive electrode plates, the separators, and the negative electrode plates.

In addition, because a mandrel, which presses and supports the electrode plate, moves in the predetermined order while operating upward, downward, leftward, or rightward, a large amount of time is required to fix or release the electrode plate.

In addition, because the positive electrode plate and the negative electrode plate are supplied by a single electrode supply device, there is a problem in that a supply rate is low, and the entire stacking apparatus needs to be stopped in case that a defect occurs in the electrode supply device.

In addition, there is a problem in that a battery is tightly attached to a pressing module and hardly detached from the pressing module during a process of pressing the battery with high pressure after the battery is manufactured.

In addition, because of the nature of the structure of the stacking apparatus, it is difficult to measure, from above, whether the stacked electrode plates are aligned, which causes a problem in that it is difficult to precisely detect a stacking defect of the electrode plates.

In addition, there is no device for automatically winding the remaining separators around an electrode assembly unloaded after the stacking process is completed, and the electrode assembly is finished manually, which causes a problem in that a working speed is low.

### DISCLOSURE

### Technical Problem

The embodiment provides a stacking apparatus in which a stage is fixed, and a stacking head rotates leftward or rightward.

The embodiment provides a stacking apparatus having a pick-up unit that removes a lower electrode plate when two electrode plates are picked up during a process of picking up the electrode plates.

The embodiment provides a stacking apparatus capable of adjusting a length and tension of a separator when a stacking head rotates.

The embodiment provides a stacking apparatus having a plurality of support units in which a vertical operation and a horizontal operation are independently controlled.

The embodiment provides a stacking apparatus having a sensor configured to detect whether two electrode plates are picked up during a process of picking up the electrode plates.

The embodiment provides a stacking apparatus having a plurality of positive electrode plate supply parts and a plurality of negative electrode plate supply parts.

The embodiment provides a stacking apparatus including a pressing module having a contact area that is adjustable after an electrode assembly is pressed.

The embodiment provides a stacking apparatus capable of capturing an image of a top surface of an electrode assembly by using a mirror.

The embodiment provides a stacking apparatus capable of winding and fixing a cut separator around an electrode assembly.

The objects to be achieved by the embodiments are not limited to the above-mentioned objects, but also include objects or effects that may be understood from the solutions or embodiments described below.

### Technical Solution

A stacking apparatus according to a first feature of the present invention includes: a stacking module including a stacking stage, and a stacking head configured to stack a positive electrode plate, a negative electrode plate, and a separator on the stacking stage; a positive electrode plate supply module configured to provide the positive electrode plate; and a negative electrode plate supply module configured to provide the negative electrode plate, in which the stacking head rotates in a first rotation direction and picks up the positive electrode plate provided by the positive electrode plate supply module, and the stacking head rotates in a second rotation direction different from the first rotation direction and picks up the negative electrode plate supplied by the negative electrode plate supply module.

A stacking apparatus according to a second feature of the present invention includes: a stacking module including a stacking stage, and a stacking head configured to stack a positive electrode plate, a negative electrode plate, and a separator on the stacking stage; a positive electrode plate supply module configured to provide the positive electrode plate; and a negative electrode plate supply module configured to provide the negative electrode plate, in which the positive electrode plate supply module includes: a first accommodation unit configured to accommodate the plurality of positive electrode plates; and a first pick-up unit configured to pick up the positive electrode plate accommodated in the first accommodation unit, and in which the first pick-up unit includes: a plurality of first sucking parts configured to suck the positive electrode plate; a body part configured to support the plurality of first sucking parts; and a vibration part configured to shake the picked-up positive electrode plate.

A stacking apparatus according to a third feature of the present invention includes: a stacking module including a stacking stage, and a stacking head configured to stack a positive electrode plate, a negative electrode plate, and a separator on the stacking stage; a positive electrode plate supply module configured to provide the positive electrode plate; a negative electrode plate supply module configured to provide the negative electrode plate; a separator supply module configured to supply a separator to the stacking head; and a tension adjustment module disposed between the separator supply module and the stacking head and configured to adjust tension of the separator.

A stacking apparatus according to a fourth feature of the present invention includes: a stacking module including a stacking stage, and a stacking head configured to stack a positive electrode plate, a negative electrode plate, and a separator on the stacking stage; a positive electrode plate supply module configured to provide the positive electrode plate; and a negative electrode plate supply module configured to provide the negative electrode plate, in which the stacking module includes a plurality of support units configured to support the positive electrode plate, the negative electrode plate, and the separator stacked on the stacking stage, in which the plurality of support units includes: a support pin; a first support driving part configured to move the support pin in a horizontal direction; and a second support driving part configured to move the support pin in a vertical direction, and in which the first support driving part and the second support driving part operate independently.

A stacking apparatus according to a fifth feature of the present invention includes: a stacking module including a stacking stage, and a stacking head configured to stack a positive electrode plate, a negative electrode plate, and a separator on the stacking stage; a positive electrode plate supply module configured to provide the positive electrode plate; and a negative electrode plate supply module configured to provide the negative electrode plate, in which the positive electrode plate supply module includes: a first accommodation unit configured to accommodate the plurality of positive electrode plates; and a first pick-up unit configured to pick up the positive electrode plate accommodated in the first accommodation unit, and in which the first pick-up unit includes: a plurality of first sucking parts configured to suck the positive electrode plate; a body part configured to support the plurality of first sucking parts; and an eddy current sensor configured to detect whether two picked-up positive electrode plates are sucked.

A stacking apparatus according to a sixth feature of the present invention includes: a stacking module including a stacking stage, and a stacking head configured to stack a positive electrode plate, a negative electrode plate, and a separator on the stacking stage; a positive electrode plate supply module configured to provide the positive electrode plate; and a negative electrode plate supply module configured to provide the negative electrode plate, in which the positive electrode plate supply module includes: a plurality of first accommodation units; a plurality of first-first pick-up units configured to pick up the positive electrode plates from the plurality of first accommodation units; and a first alignment stage configured to supply the positive electrode plate to the stacking head, in which the negative electrode plate supply module includes: a plurality of second accommodation units; a plurality of second-first pick-up units configured to pick up the negative electrode plates from the plurality of second accommodation units; and a second alignment stage configured to supply the negative electrode plate to the stacking head, and in which the positive electrode plates picked up by the first-first pick-up unit and the positive electrode plates picked up by the second-first pick-up unit are alternately seated on the first alignment stage.

### Advantageous Effects

The embodiment provides the stacking apparatus in which the stage is fixed and the stacking head rotates leftward or rightward, thereby reducing the size of the stacking apparatus.

In addition, the embodiment provides the stacking apparatus having the pick-up unit that removes the lower electrode plate when two electrode plates are picked up during the process of picking up the electrode plates, thereby preventing a defect of the electrode assembly by removing the electrode plate attached to the lower portion of another picked-up electrode plate.

In addition, the embodiment provides the stacking apparatus capable of adjusting the length and tension of the separator when the stacking head rotates, thereby preventing a stacking defect of the separator.

In addition, the embodiment provides the stacking apparatus having the plurality of support units in which a vertical operation and a horizontal operation are independently controlled, thereby reducing the TAC time by reducing the amount of time required for the support unit to fix or release the electrode plate.

In addition, the embodiment provides the stacking apparatus having the sensor configured to detect whether two electrode plates are picked up during the process of picking up the electrode plates, thereby preventing a defect of the electrode assembly by detecting, at an early stage, whether the two electrode plates are picked up.

In addition, the embodiment provides the stacking apparatus having the plurality of positive electrode plate supply parts and the plurality of negative electrode plate supply parts, thereby increasing the working speed. Further, even in case that some of the supply parts are defective, the remaining supply parts supply the electrode plates, such that the repair may be performed without stopping the stacking apparatus.

In addition, the embodiment provides the stacking apparatus including the pressing module having the contact area that is adjustable after the electrode assembly is pressed, thereby easily separating the electrode assembly from the pressing module after the pressing process.

In addition, the embodiment provides the stacking apparatus that captures images of the top surface of the electrode assembly by means of the mirror, thereby precisely detecting a stacking defect of the electrode assembly.

In addition, the embodiment provides the stacking apparatus in which the end of the cut separator is wound around and fixed to the electrode assembly, such that the end of the separator produced during the process of cutting the electrode assembly may be automatically wound around and fixed to the electrode assembly.

The various, beneficial advantages and effects of the present invention are not limited to the above-mentioned contents and may be more easily understood during the process of describing the specific embodiments of the present invention.

### DESCRIPTION OF DRAWINGS

FIG. 1 is a view schematically illustrating a workflow of a stacking apparatus according to the embodiment.

FIGS. 2A and 2B are views illustrating the order according to the embodiment in which positive electrode plates and negative electrode plates are transported.

FIG. 3 is a view illustrating the order according to another embodiment in which the positive electrode plates and the negative electrode plates are transported.

FIG. 4 is a view illustrating the order according to still another embodiment in which the positive electrode plates and the negative electrode plates are transported.

FIG. 5 is a view illustrating the stacking apparatus according to the embodiment.

FIG. 6 is a view illustrating a first accommodation unit, a first transfer unit, and a positive electrode plate inspection unit according to the embodiment.

FIGS. 7A to 7E are views illustrating a process in which a positive electrode plate accommodated in the first accommodation unit is transferred to the positive electrode plate inspection unit.

FIG. 8A is a view illustrating a first-first pick-up unit according to the embodiment.

FIG. 8B is a view illustrating a process in which the first-first pick-up unit removes two electrode plates attached to each other.

FIGS. 9A and 9B are views illustrating a process in which a sucking part disposed on a sub-block rotates.

FIG. 10 is a view illustrating a first-first pick-up unit according to another embodiment.

FIGS. 11A and 11B are views illustrating a process in which an electrode plate is bent as the sucking part of the first-first pick-up unit is tilted.

FIG. 12 is a view illustrating an inspection unit according to the embodiment.

FIG. 13 is an image of a positive electrode plate disposed on a first alignment stage.

FIG. 14 is an image of a negative electrode plate disposed on a second alignment stage.

FIGS. 15A to 15C are views illustrating a process in which a positive electrode plate, a negative electrode plate, and a separator are stacked on a stacking stage by a stacking head.

FIG. 16 is a view illustrating a stacking stage and a plurality of support units according to the embodiment.

FIG. 17 is a view illustrating a three-axis operation of the support unit.

FIG. 18 is a view illustrating a state in which the plurality of support units press an electrode plate.

FIG. 19 is a view illustrating a separator supply module according to the embodiment.

FIG. 20 is a view illustrating a state in which tension of a separator is adjusted by the separator supply module according to the embodiment.

FIG. 21 is a view illustrating a process of inspecting alignment of an electrode assembly stacked on the stacking stage.

FIG. 22 is a top plan view illustrating a state in which a positive electrode plate is sucked by a third pick-up module.

FIG. 23 is a view illustrating a process of determining whether a positive electrode plate is aligned on the basis of a captured image of the positive electrode plate.

FIG. 24 is a view illustrating a state in which a pulling module of the stacking apparatus according to the embodiment approaches an electrode assembly.

FIG. 25 is a perspective view illustrating a cutting module and the pulling module according to the embodiment.

FIGS. 26A to 26E are views illustrating states in which the pulling module extracts an electrode assembly rearward.

FIG. 27 is a view illustrating a state in which an electrode assembly is moved to one side of the stacking apparatus by the pulling module according to the embodiment.

FIG. 28 is a view illustrating a winding module according to the embodiment.

FIG. 29 is a view illustrating a state in which a guide bar is supported by a hook of a clamping unit.

FIG. 30A is a view illustrating a state in which an electrode assembly is fitted with the guide bar of the winding module.

FIG. 30B is a view illustrating a state in which a separator of an electrode assembly is wound as first and second rotation parts of the winding module are rotated.

FIG. 31 is a view illustrating a heating module of one embodiment.

FIG. 32 is a view illustrating a pressing module of one embodiment.

FIG. 33 is a view illustrating a diaphragm disposed on a lower pressing plate.

FIG. 34 is a view illustrating a state in which an electrode assembly and the lower pressing plate are separated as the diaphragm on the lower pressing plate expands.

FIG. 35 is a view illustrating a state in which the diaphragm is disposed on the lower pressing plate and an upper pressing plate.

FIG. 36 is a view illustrating a state in which an electrode assembly and the upper pressing plate are separated as the diaphragm on the upper pressing plate expands.

FIG. 37 is a view illustrating a state in which an electrode assembly and the lower pressing plate are separated as the diaphragm on the lower pressing plate expands.

### MODE FOR INVENTION

The present invention may be variously modified and may have various forms, and particular embodiments illustrated in the drawings will be described in detail below. However, the description of the embodiments is not intended to limit the present invention to the particular embodiments, but it should be understood that the present invention is to cover all modifications, equivalents and alternatives falling within the spirit and technical scope of the present invention.

The terms including ordinal numbers such as ‘second’, ‘first’, and the like may be used to describe various constituent elements, but the constituent elements are not limited by the terms. These terms are used only to distinguish one constituent element from another constituent element. For example, a second component may be named a first component, and similarly, the first component may also be named the second component, without departing from the scope of the present invention. The term “and/or” includes any and all combinations of a plurality of the related and listed items.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

The terminology used herein is used for the purpose of describing particular embodiments only and is not intended to limit the present invention. Singular expressions include plural expressions unless clearly described as different meanings in the context. The terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present application.

Hereinafter, embodiments will be described in detail with reference to the accompanying drawings. The same or corresponding constituent elements are assigned with the same reference numerals regardless of reference numerals, and the repetitive description thereof will be omitted.

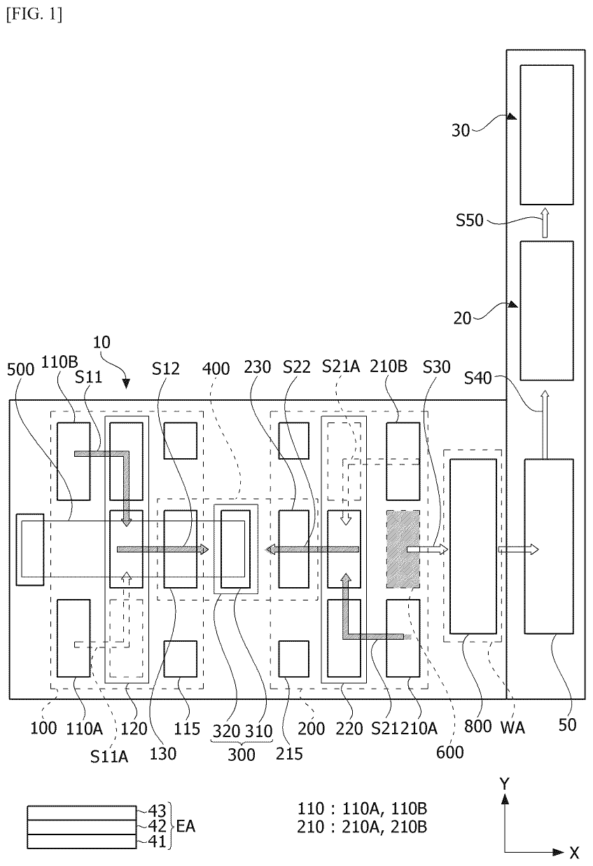

FIG. 1 is a view schematically illustrating a workflow of a stacking apparatus according to the embodiment.

With reference to FIG. 1, a stacking apparatus according to the embodiment of the present invention may include a positive electrode plate supply module 100, a negative electrode plate supply module 200, a separator supply module 500, a stacking module 300 including a stacking stage 320 and a stacking head 310, a pulling module 600 configured to extract a stacked electrode assembly EA, a winding module 800 configured to finish a separator 43 of the electrode assembly EA, a heating module 20 configured to bond the electrode assembly EA, and a pressing module 30 configured to press the electrode assembly EA.

The stacking apparatus according to the embodiment may include only some of the above-mentioned components. For example, the stacking apparatus according to the embodiment may include the positive electrode plate supply module 100, the negative electrode plate supply module 200, the separator supply module 500, the stacking stage 320, and the stacking head 310.

Alternatively, the stacking apparatus according to the embodiment may include the positive electrode plate supply module 100, the negative electrode plate supply module 200, the separator supply module 500, the stacking stage 320, the stacking head 310, the pulling module 600, and the winding module 800. That is, the stacking apparatus according to the embodiment may be defined as an apparatus including at least one of the above-mentioned constituent elements.

The positive electrode plate supply module 100 may serve to supply a plurality of positive electrode plates 41 accommodated in a first accommodation unit (magazine) 110 so that the stacking head 310 may sequentially pick up the plurality of positive electrode plates 41.

The positive electrode plate 41 accommodated in the first accommodation unit 110 may be moved to a first transfer unit 120 disposed adjacent to the first accommodation unit 110 in a first direction (X-axis direction). Thereafter, the positive electrode plate 41 may be disposed on a first alignment stage 130 by the first transfer unit 120.

At least one pick-up unit may be disposed on the positive electrode plate supply module 100, and the pick-up unit may move the positive electrode plate 41 accommodated in the first accommodation unit 110 from the first accommodation unit 110 to the first transfer unit 120 (S11) and move the positive electrode plate 41 from the first transfer unit 120 to the first alignment stage 130 again (S12).

For example, the positive electrode plate supply module 100 may include a first-first pick-up unit 140 configured to move the positive electrode plate 41 accommodated in the first accommodation unit 110 to the first transfer unit 120, and a first-second pick-up unit 150 configured to move the positive electrode plate 41 from the first transfer unit 120 to the first alignment stage 130. However, the present invention is not necessarily limited thereto. A single pick-up unit may move the positive electrode plate 41.

The positive electrode plate supply module 100 may include first and second positive electrode plate supply parts disposed adjacent to each other in a second direction (Y-axis direction). The first positive electrode plate supply part may include a first-first accommodation unit 110A and the first-first pick-up unit. The second positive electrode plate supply part may include a first-second accommodation unit 110B and the first-first pick-up unit.

The first accommodation unit 110 may include the first-first accommodation unit 110A and the first-second accommodation unit 110B disposed to face each other in the second direction (Y-axis direction). The first-first accommodation unit 110A may be disposed at one side based on the second direction, and the first-second accommodation unit 110B may be disposed at the other side based on the second direction.

Therefore, the first direction (X-axis direction) in which the first-first accommodation unit 110A and the first-second accommodation unit 110B are spaced apart from each other may be perpendicular to the first direction (Y-axis direction) in which the positive electrode plate supply module and the negative electrode plate supply module are spaced apart from each other.

With this configuration, the positive electrode plate 41 picked up from the first-first accommodation unit 110A may be moved to the first alignment stage 130 by the first transfer unit 120 (S11A), and then the positive electrode plate 41 picked up from the first-second accommodation unit 110B may be sequentially moved to the first alignment stage 130 by the first transfer unit 120 (S11). Therefore, it is possible to reduce a TAC time required to supply the positive electrode plate 41 to the stacking head 310. In addition, even though one supply part is defective, another supply part may continuously supply the positive electrode plate 41, such that the defective supply part may be repaired without stopping the stacking apparatus.

The speed of manufacturing the electrode assembly EA is determined depending on a total sum of the amounts of time required for respective steps including the amount of time required to take the electrode plate from the accommodation unit, the amount of time required to align the electrode plate, the amount of time required to stack the aligned electrode plate on the stacking stage, and the amount of time required to alternately stack the negative electrode plates and the positive electrode plates. Therefore, it may be important to shorten the working time for each step.

In the embodiment, the electrode plates are alternately supplied to the stacking head 310 by the first-first accommodation unit 110A and the first-second accommodation unit 110B (S11 and S11A). Therefore, it is possible to reduce the amount of time required to take the electrode plates from the accommodation units.

The negative electrode plate supply module 200 and the positive electrode plate supply module 100 may be disposed to be symmetric in the first direction with respect to the stacking head 310. At least one pick-up unit may be disposed on the negative electrode plate supply module 200, and the pick-up unit may move a negative electrode plate 42 accommodated in a second accommodation unit 210 to a second transfer unit 220 (S21) and move the negative electrode plate 42 from the second transfer unit 220 to a second alignment stage 230 (S22).

The second accommodation unit 210 of the negative electrode plate supply module 200 may include a second-first accommodation unit 210A and a second-second accommodation unit 210B disposed to face each other in the second direction. The second-first accommodation unit 210A may be disposed at one side based on the second direction, the second-second accommodation unit 210B may be disposed at the other side based on the second direction, and the second-first accommodation unit 210A and the second-second accommodation unit 210B may alternately supply the negative electrode plates 42 (S21 and S21A). Therefore, it is possible to reduce a TAC time required to supply the negative electrode plate 42 to the stacking head 310.

However, the present invention is not necessarily limited thereto. The second-first accommodation unit 210A and the second-second accommodation unit 210B may be disposed to face each other in the first direction (X-axis direction). Therefore, the second-second accommodation unit 210B may be disposed at a position of a collection unit 215.

The separator supply module 500 may supply the separator 43 to the stacking head 310. The separator 43 may traverse an upper side of the positive electrode plate supply module 100 by means of a plurality of rollers, and the separator 43 may be supplied to the stacking head 310.

The stacking head 310 may stack the positive electrode plate 41 received from the positive electrode plate supply module 100, the negative electrode plate 42 received from the negative electrode plate supply module 200, and the separator 43 received from the separator supply module 500 on the stacking stage 320, thereby manufacturing the electrode assembly EA. The electrode assembly may be a concept including all various cells that may serve as batteries.

The pulling module 600 may move in the first direction through a lower side of the negative electrode plate supply module 200 and approach the completely stacked electrode assembly EA. Thereafter, the pulling module 600 may transport the electrode assembly EA to a finishing region WA while retracting in a state in which the pulling module 600 holds the electrode assembly EA (S30).

The winding module 800 disposed in the finishing region may wind the separator 43 remaining on the electrode assembly EA and then bond the separator 43 to the electrode assembly EA. The completely finished electrode assembly EA may be moved to a position at which a transport unit 50 is disposed, and then the electrode assembly EA may be moved to the heating module 20 by the transport unit 50 (S40).

The stack-type electrode assembly EA requires a lamination process of joining the electrode and the separator 43. In general, the lamination process performs a process of bonding the electrode plate and the separator by heating the electrode assembly EA having the structure in which the positive electrode plate 41 and the negative electrode plate 42 are stacked with the separator 43 interposed therebetween.

The heating module 20 according to the embodiment may have a so-called high-frequency induction heating structure that generates heat by applying high-frequency waves to a metal conductor. The high-frequency induction heating refers to a method that generates an eddy current in the vicinity of a surface of the metal conductor by applying high-frequency waves to the metal conductor and heats the metal conductor by using a phenomenon in which a loss of electric power caused by the eddy current is converted into a thermal loss.

The high-frequency induction heating is advantageous in heating the metal in a non-contact manner. That is, because a current collector present in the electrode assembly EA may be heated directly, a plurality of heating points are positioned in the entire electrode assembly EA, such that a thermal conduction section is shortened, and a temperature deviation is reduced. Because a temperature deviation in the electrode assembly EA is reduced, it is not necessary to excessively apply heat to raise a temperature to a temperature required for thermal bonding, which consequently improves energy efficiency.

The completely heated electrode assembly EA may be moved to the pressing module 30 (S50). The pressing module 30 may join the electrode plate to the separator by pressing the electrode assembly EA at a predetermined temperature. In the embodiment, the heating module 20 and the pressing module 30 have been described separately, but the heating module 20 and the pressing module 30 may be simultaneously operated by a single apparatus.

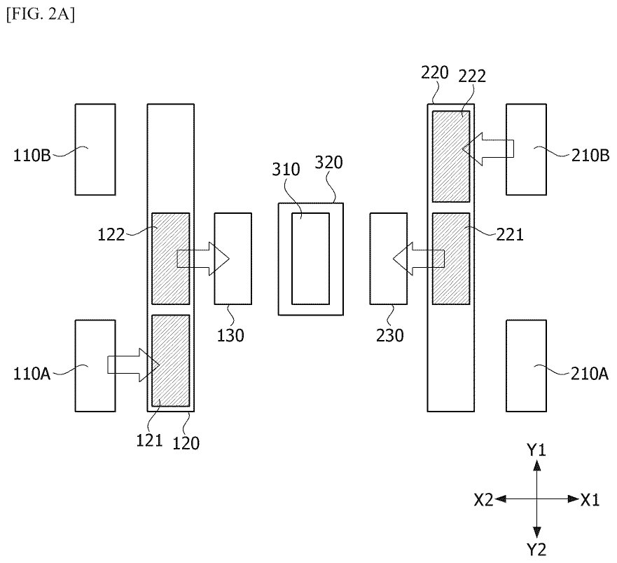

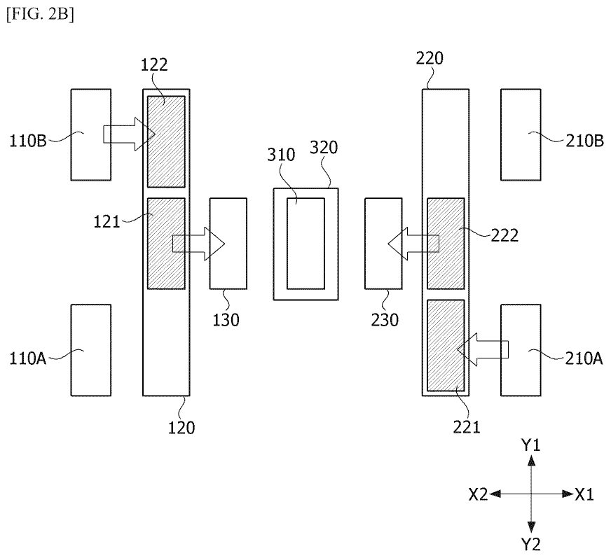

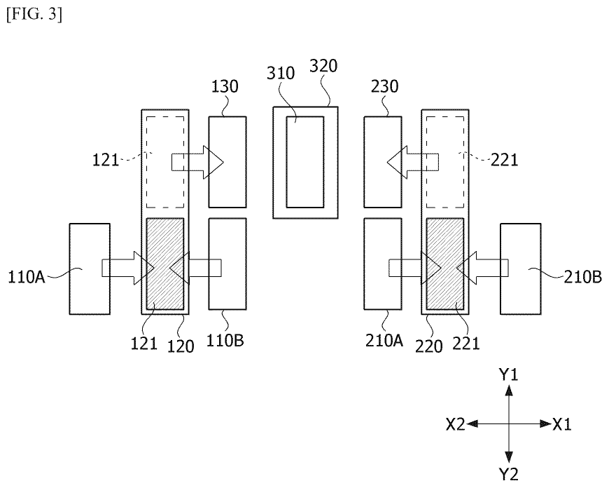

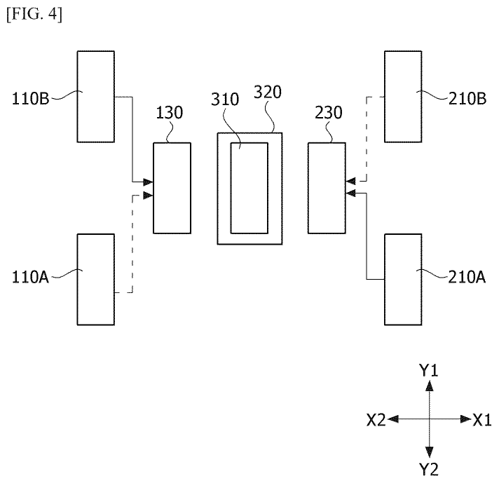

FIGS. 2A and 2B are views illustrating the order according to the embodiment in which the positive electrode plates and the negative electrode plates are transported. FIG. 3 is a view illustrating the order according to another embodiment in which the positive electrode plates and the negative electrode plates are transported. FIG. 4 is a view illustrating the order according to still another embodiment in which the positive electrode plates and the negative electrode plates are transported.

With reference to FIGS. 2A and 2B, the first transfer unit 120 may include a first-first transfer stage 121 configured to transport the positive electrode plate accommodated in the first-first accommodation unit 110A, and a first-second transfer stage 122 configured to transport the positive electrode plate accommodated in the first-second accommodation unit 110B.

The first-first transfer stage 121 and the first-second transfer stage 122 may alternately transport the positive electrode plates to the first alignment stage 130. As illustrated in FIG. 2A, the positive electrode plate accommodated in the first-first accommodation unit 110A may be seated on the first-first transfer stage 121 when the first-second transfer stage 122 transports the positive electrode plate accommodated in the first-second accommodation unit 110B to the first alignment stage 130.

Thereafter, as illustrated in FIG. 2B, the positive electrode plate accommodated in the first-second accommodation unit 110B may be seated on the first-second transfer stage 122 when the first-first transfer stage 121 transports the positive electrode plate to the first alignment stage 130.

The first-first and first-second transfer stages 121 and 122 of the first transfer unit 120 and the second-first and second-second transfer stages 221 and 222 of the second transfer unit may move in the opposite directions. For example, as illustrated in FIG. 2A, the second-first and second-second transfer stages 221 and 222 of the second transfer unit 220 may move in a second-first direction (Y1-axis direction) when the first-first and first-second transfer stages 121 and 122 of the first transfer unit 120 move in a second-second direction (Y2-axis direction).

Therefore, the first-first and first-second transfer stages 121 and 122 of the first transfer unit 120 and the second-first and second-second transfer stages 221 and 222 of the second transfer unit 220 may be disposed in a zigzag manner and supply the positive electrode plates and the negative electrode plates.

With reference to FIG. 3, the first-first accommodation unit 110A and the first-second accommodation unit 110B may be disposed to face each other in the first direction (X-axis direction). In addition, the second-first accommodation unit 210A and the second-second accommodation unit 210B may be disposed to face each other in the first direction. With this configuration, it is possible to reduce the size of the stacking apparatus because a space in which the first-second accommodation unit and the second-second accommodation unit have been disposed to be spaced apart from each other in the second direction (Y-axis direction) in the related art may be reduced.

The first transfer unit 120 may alternately transfer the positive electrode plates accommodated in the first-first accommodation unit 110A and the first-second accommodation unit 110B to the first alignment stage 130. In this case, the first transfer unit 120 may transfer the positive electrode plate to one transfer stage, and the plurality of transfer stages may alternately transfer the positive electrode plates accommodated in the first-first accommodation unit 110A and the first-second accommodation unit 110B to the first alignment stage 130 while moving without intersecting one another. For example, when the first transfer stage moves, the second transfer stage may move vertically upward and move without intersecting the first transfer stage.

The second transfer unit 220 may alternately transfer the negative electrode plates accommodated in the second-first accommodation unit 210A and the second-second accommodation unit 210B to the second alignment stage 230. In this case, the second transfer unit may transfer the negative electrode plate to one transfer stage, and the plurality of transfer stages may alternately transfer the negative electrode plates accommodated in the second-first accommodation unit 210A and the second-second accommodation unit 210B to the first alignment stage 130 while moving without intersecting one another.

With reference to FIG. 4, the positive electrode plates accommodated in the first-first accommodation unit 110A and the first-second accommodation unit 110B may be immediately transferred to the first alignment stage 130 by a pick-up module without a separate transfer unit. In addition, the negative electrode plates accommodated in the second-first accommodation unit 210A and the second-second accommodation unit 210B may be immediately transferred to the second alignment stage 230 by a pick-up module without a separate transfer unit. With this configuration, the transfer unit may be excluded, and the size of the stacking apparatus may be reduced.

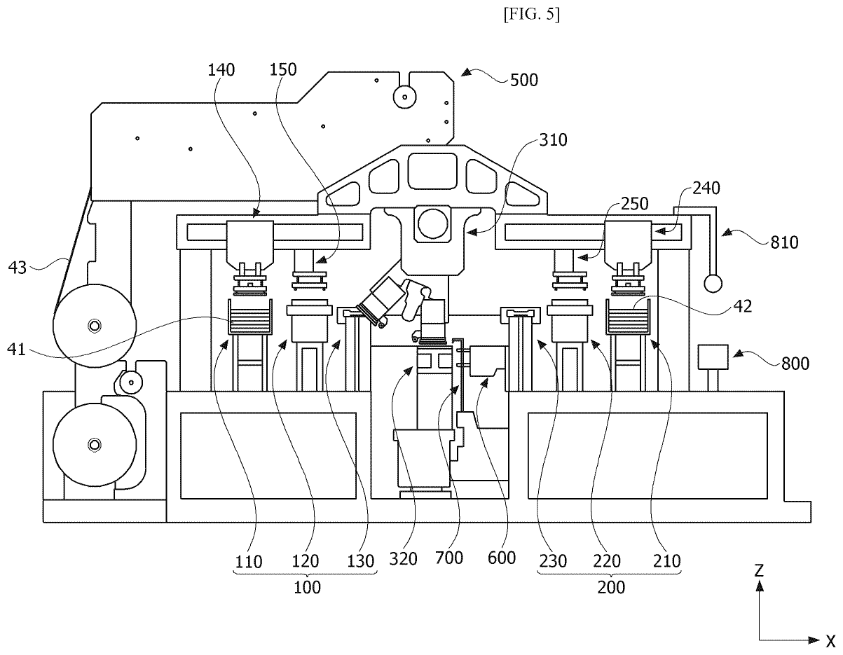

FIG. 5 is a view illustrating the stacking apparatus according to the embodiment.

With reference to FIG. 5, the stacking apparatus according to the embodiment includes the stacking stage 320 on which the positive electrode plate 41, the negative electrode plate 42, and the separator 43 are stacked, the positive electrode plate supply module 100 configured to supply the positive electrode plate 41 to the stacking stage 320, the negative electrode plate supply module 200 configured to supply the negative electrode plate 42 to the stacking stage 320, and the stacking head 310 configured to stack the positive electrode plate 41, which is provided from the positive electrode plate supply module 100, and the negative electrode plate 42, which is supplied from the negative electrode plate supply module 200, on the stacking stage 320.

Based on the stacking head 310, the positive electrode plate supply module 100 may be disposed at one side, and the negative electrode plate supply module 200 may be disposed at the other side.

The positive electrode plate supply module 100 may include the first accommodation unit 110, the first transfer unit 120, and the first alignment stage 130 disposed in the first direction. The first-first pick-up unit 140 may move the positive electrode plate 41 accommodated in the first accommodation unit 110 to the first transfer unit 120, and the first-second pick-up unit 150 may move the positive electrode plate 41 disposed on the first transfer unit 120 to the first alignment stage 130.

The negative electrode plate supply module 200 may include the second accommodation unit 210, the second transfer unit 220, and the second alignment stage 230. A second-first pick-up unit 240 may move the negative electrode plate 42 accommodated in the second accommodation unit 210 to the second transfer unit 220, and a second-second pick-up unit 250 may move the negative electrode plate 42 disposed on the second transfer unit 220 to the second alignment stage 230.

The stacking stage 320 and the stacking head 310 may be disposed between the positive electrode plate supply module 100 and the negative electrode plate supply module 200. The separator supply module 500 may transport the separator 43 to the upper side of the positive electrode plate supply module 100 and supply the separator 43 to the stacking head 310.

The pulling module 600 and a cutting module 700 may be disposed below the stacking head 310. According to the embodiment, the pulling module 600 and the cutting module 700 may be disposed around the stacking stage 320, such that the size of the apparatus may be reduced.

A structure in which the stacking stage 320 stacks the positive electrode plate and the negative electrode plate while moving leftward and rightward requires a space in which the stacking stage 320 swings leftward and rightward. For this reason, because the pulling module and the cutting module need to be relatively and sufficiently spaced apart from the stacking stage, there is a problem in that the size of the apparatus needs to be increased.

In contrast, the embodiment provides the structure in which the stacking stage 320 is fixed and the stacking head 310 swings, such that the pulling module 600 and the cutting module 700 may be disposed in the vicinity of the stacking stage 320 even during the stacking process, which may reduce the size of the apparatus.

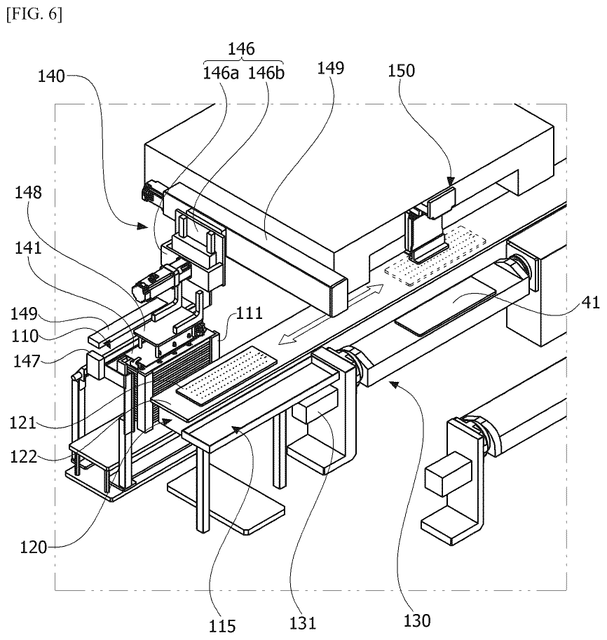

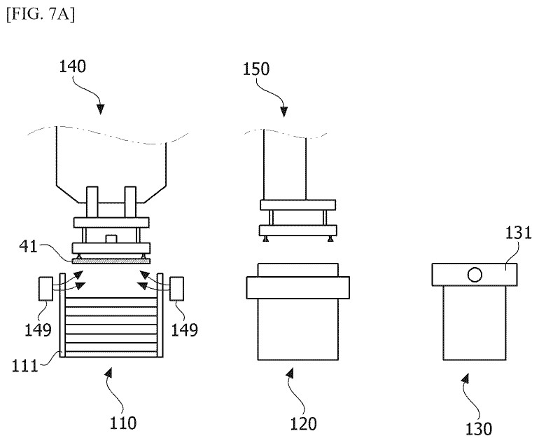

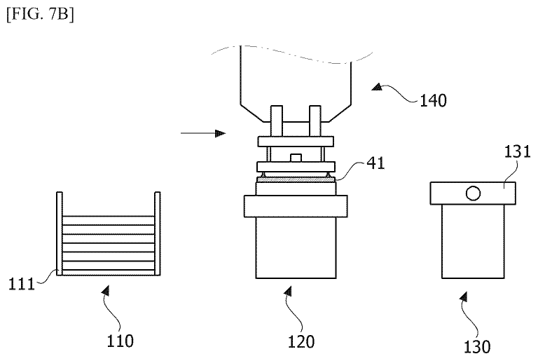

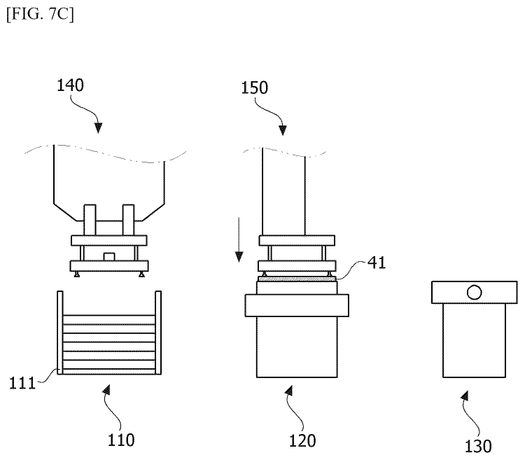

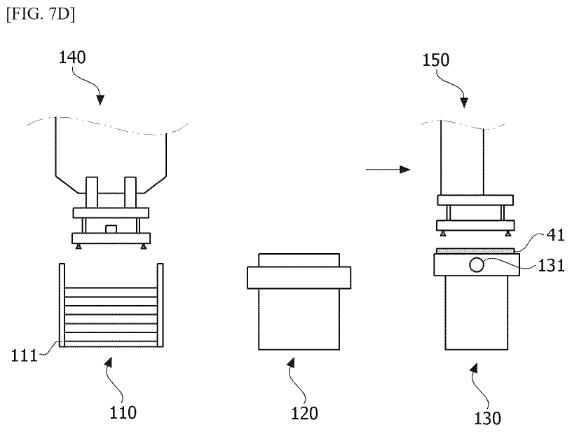

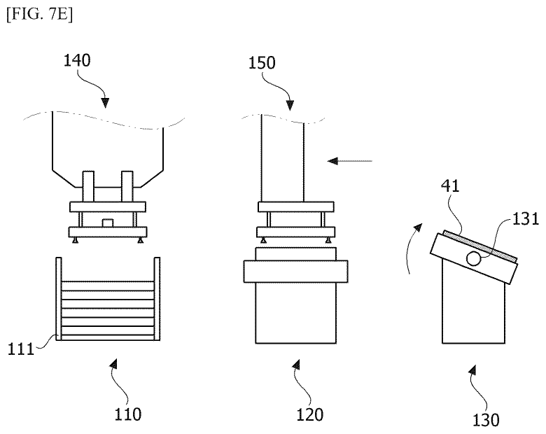

FIG. 6 is a view illustrating the first accommodation unit, the first transfer unit, and a positive electrode plate inspection unit according to the embodiment. FIGS. 7A to 7E are views illustrating a process in which the positive electrode plate accommodated in the first accommodation unit is transferred to the positive electrode plate inspection unit.

With reference to FIGS. 6, 7A, and 7B, the first-first pick-up unit 140 of the positive electrode plate supply module 100 may pick up the positive electrode plate 41 accommodated in the first accommodation unit 110 and move the positive electrode plate 41 to the first transfer stage 121 of the first transfer unit 120 disposed adjacent to the first accommodation unit 110.

A spray unit 149 may be disposed on a lateral surface of the first accommodation unit 110 and spray air to the positive electrode plate picked up by the first-first pick-up unit 140. With this configuration, because the air is sprayed between the positive electrode plates when the positive electrode plates are picked up, the electrode plates may be easily separated.

The first transfer unit 120 may include a rail part 122 disposed to extend in the second direction, and the first transfer stage 121 disposed on the rail part 122 and configured to reciprocate in the second direction. When the positive electrode plate 41 is seated on the first transfer stage 121, the first transfer stage 121 may move to a point adjacent to the first alignment stage 130.

With reference to FIG. 7C, and FIG. 7D, the first-second pick-up unit 150 may pick up the positive electrode plate 41 transported by the first transfer stage 121 and dispose the positive electrode plate 41 on the first alignment stage 130. The first-second pick-up unit 150 may move in a direction parallel to the movement direction of the first-first pick-up unit 140.

According to the embodiment, all various methods of moving the positive electrode plate 41 by the pick-up unit may be applied. For example, when the positive electrode plate 41 is disposed on the first transfer stage 121, the first-second pick-up unit 150 may move to an upper side of the first transfer stage 121, pick up the positive electrode plate 41, and then dispose the positive electrode plate 41 on the first alignment stage 130. Alternatively, the first-first pick-up unit 140 may pick up the positive electrode plate 41 from the first accommodation unit 110, move, and then dispose the positive electrode plate 41 directly on the first alignment stage 130.

With reference to FIG. 7E, the first alignment stage 130 may rotate toward the stacking head 310 so that the stacking head 310 may pick up the positive electrode plate 41. A stage driving part 131 may rotate the first alignment stage 130 toward the stacking head 310 and then return the first alignment stage 130 back to an original position.

The negative electrode plate supply module 200 may have the same configuration as that illustrated in FIGS. 7A to 7E and provide the negative electrode plate 42 to the stacking head 310. The negative electrode plate supply module 200 may be identical in configuration and operation to the positive electrode plate supply module 100, except that the negative electrode plate supply module 200 supplies the negative electrode plate 42.

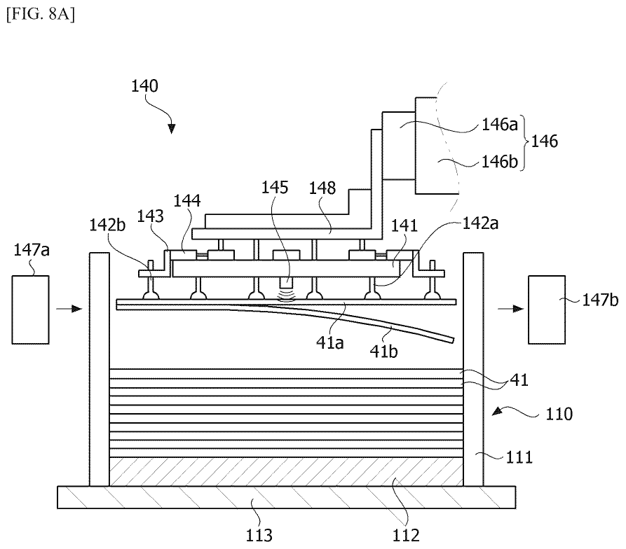

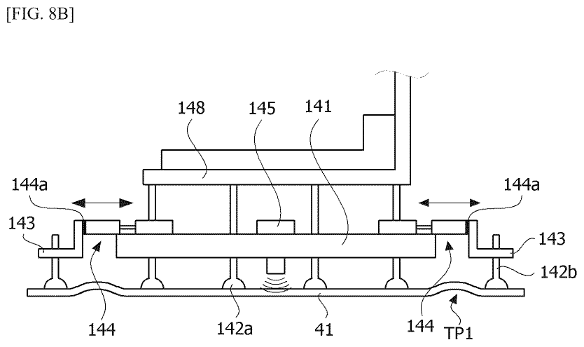

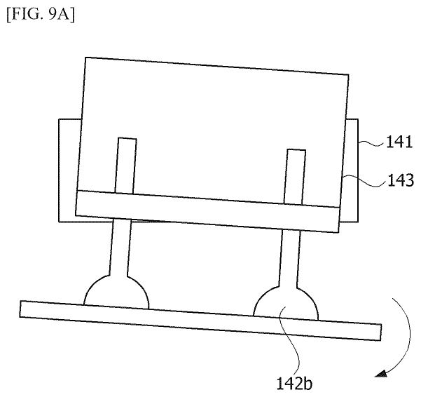

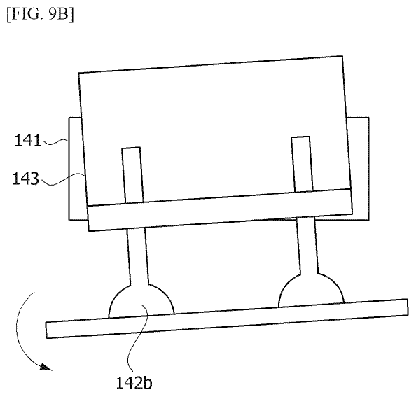

FIG. 8A is a view illustrating the first-first pick-up unit according to the embodiment. FIG. 8B is a view illustrating a process in which the first-first pick-up unit removes two electrode plates attached to each other. FIGS. 9A and 9B are views illustrating a process in which a sucking part disposed on a sub-block rotates.

With reference to FIGS. 8A and 8B, the plurality of positive electrode plates 41 are stacked on the first accommodation unit 110, and a height adjustment part 112 may be disposed at a lower side of the first accommodation unit 110. Therefore, a height of the positive electrode plate 41 at an uppermost side may always be constantly maintained even though the number of positive electrode plated 41 decreases. The first accommodation unit 110 may include a plurality of fixing frames 111 configured to fix edges of the plurality of positive electrode plates, and a fixing plate 113 configured to fix the plurality of fixing frames 111.

The first-first pick-up unit 140 may pick up the positive electrode plate 41 in an uppermost layer. However, two positive electrode plates 41 are sometimes picked up. Hereinafter, a case in which the plurality of electrode plates are attached to one another is defined as a case in which two electrode plates are attached to each other but apparently includes a case in which two or more electrode plates are attached to one another. Because the electrode plate, such as the positive electrode plate 41 and the negative electrode plate 42, is made of a metallic material, the plurality of electrode plates may be attached to one another by an electrostatic force in case that the plurality of electrode plates are stacked. Because a defect occurs in case that two identical electrode plates are stacked during the process of manufacturing the electrode assembly, it is necessary to remove the electrode plate attached to a lower portion of another electrode plate.

An eddy current displacement sensor (first sensor) 145 may be disposed on the first-first pick-up unit 140. The eddy current displacement sensor 145 uses a high-frequency magnetic field. When a metal approaches a high-frequency magnetic field, a vortex-shaped eddy current flows in the metal by electromagnetic induction.

The eddy current is concentrated on the metal surface and decreases as an exponential function in accordance with a depth of the metal. The eddy current varies depending on an intensity and frequency of a high-frequency magnetic field, conductivity of a metal, a transmittance rate, and the like. A distance may be measured by using the property that the high-frequency impedance changes when the distance between the sensor coil and the metal plate changes. Therefore, the impedance changes in case that two electrode plates are attached to each other, such that the state in which the two electrode plates are picked up may be ascertained.

Second sensors 147a and 147b including a transmitting part 147a and a receiving part 147b may be disposed at two opposite sides of the first accommodation unit 110. When the transmitting part 147a emits light, the receiving part 147b disposed opposite to the transmitting part 147a may receive the light. For example, the transmitting part 147a and the receiving part 147b may be fiber sensors. However, the present invention is not necessarily limited thereto. The transmitting part 147a and the receiving part 147b may be applied without limitation as long as one part transmits a signal and the other part receives the signal.

Only a partial region of the positive electrode plate (hereinafter, referred to as a ‘first positive electrode plate’) accommodated in the first accommodation unit 110 and disposed in the uppermost layer and only a partial region of the positive electrode plate (hereinafter, referred to as a ‘second positive electrode plate’) disposed below the first positive electrode plate may be attached to each other by electrostatic force. Therefore, in case that the first positive electrode plate 41a is picked up by the first-first pick-up unit 140, only a partial region of the second positive electrode plate 41b may be attached to the first positive electrode plate 41a, and the remaining region of the second positive electrode plate 41b may be separated from the first positive electrode plate 41a. In this case, in case that the first positive electrode plate 41a and the second positive electrode plate 41b are separated in a region detected by the eddy current displacement sensor 145, the eddy current displacement sensor 145 may erroneously recognize the first positive electrode plate 41a and the second positive electrode plate 41b as one positive electrode plate.

However, according to the embodiment, in case that a part of the second positive electrode plate 41 is separated, a transmission signal of the transmitting part 147a is blocked, and the receiving part 147b cannot receive the transmission signal. Therefore, a control unit (not illustrated) of the stacking apparatus may determine that one positive electrode plate is picked up in response to a detection signal of the eddy current displacement sensor 145. However, if the detection signal of the receiving part 147b is not inputted, the control unit may determine that two positive electrode plates are attached to each other.

In order to quickly sense the two electrode plates during the process in which the pick-up module picks up the electrode plate, the transmitting part 147a and the receiving part 147b may be disposed to be lower than an uppermost end of the accommodation unit 110.

According to the embodiment, the control unit may receive a signal from the eddy current displacement sensor and detect whether two electrode plates are attached to each other. In case that the two electrode plates are not detected, the control unit may receive a signal from the second sensor and identify again whether two electrode plates are attached to each other. If the control unit receives a signal from the eddy current displacement sensor and determines that two electrode plates are attached to each other, the control unit may not receive a signal from the second sensor.

In addition, in case that a plurality of eddy current displacement sensors 145 are disposed on a body part 141, whether two positive electrode plates are attached to each other may be detected at different positions, such that a situation in which two positive electrode plates are partially separated from each other may be sensed.

In addition, the sensing process may be performed after vibration is applied to the previously picked-up electrode plate before the sensing process. The pick-up unit may separate the two electrode plates by shaking the electrode plates while moving upward or downward, vibrating, or rotating.

The first-first pick-up unit 140 may include the body part 141 having a plurality of sucking parts 142a configured to pick up the positive electrode plate 41, and a pick-up movement part 146 configured to move the body part 141 in the vertical direction and/or the leftward/rightward direction. The pick-up movement part 146 may include a first movement part 146a configured to move the body part 141 upward or downward, and a second movement part 146b configured to move the body part 141 leftward or rightward. The pick-up movement part 146 may further include a third movement part (not illustrated) configured to rotate the body part 141 clockwise and counterclockwise.

The sucking part 142a may be connected to a vacuum pump and suck a top surface of the positive electrode plate 41. However, the present invention is not necessarily limited thereto. Various structures capable of being attached to or detached from the top surface of the positive electrode plate 41 may be applied as the sucking part 142a without limitation. In addition, the number of sucking parts 142a may be variously changed.

Vibration parts may be disposed at two opposite ends of the body part 141. Vibration parts may include sub-blocks 143 on which auxiliary sucking parts 142b are disposed, and block driving parts 144 connected to the body part 141 and configured to operate the sub-blocks 143.

The sub-blocks 143 may include a first sub-block disposed at one end of the body part 141, and a second sub-block disposed at the other side of the body part 141. However, the number of sub-blocks may be variously changed.

The block driving part 144 may be connected to the body part 141 and the sub-block 143 and move the sub-block 143 toward or away from the body part 141. Various drive means, such as a motor or a cylinder, may be applied as the block driving part 144.

In addition, the block driving part 144 may move the sub-block 143 in the vertical direction. That is, the block driving part 144 may move the sub-block 143 in various directions to separate two electrode plates. For example, an elastic member 144a, such as a flat spring, may be further disposed between the sub-block 143 and the body part 141.

With reference to FIG. 8B, when the sub-block 143 is moved away from the body part 141 by the block driving part 144, a distance between the auxiliary sucking part 142b disposed on the sub-block 143 and the sucking part 142a disposed on the body part 141 is changed, such that a partial region TP1 of the positive electrode plate 41 may be repeatedly deformed and bent. These various vibration effects transmit a force, which is higher than an electrostatic force between the electrode plates, to the electrode plates, such that one electrode plate attached to the lower portion of another electrode plate may be separated. The separated positive electrode plate 41 may be accommodated in a collection unit 115.

According to the embodiment, the first-first pick-up unit 140 may apply vibration to the positive electrode plate 41 by operating the block driving part 144 when the first-first pick-up unit 140 picks up the positive electrode plate 41.

With reference to FIGS. 9A and 9B, the sub-block 143 may be rotated by the block driving part 144. Therefore, the auxiliary sucking part 142b disposed on the sub-block 143 swings, and the sucking part 142a disposed on the body part 141 is fixed, such that warping may occur between a portion of the electrode plate sucked by the auxiliary sucking part 142b and a portion of the electrode plate sucked by the sucking part 142a. Therefore, in case that two electrode plates are attached to each other, the two electrode plates may be effectively separated.

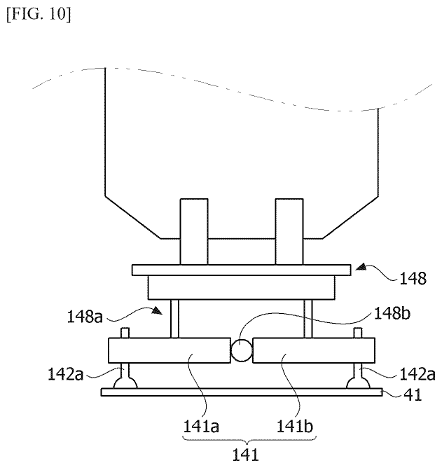

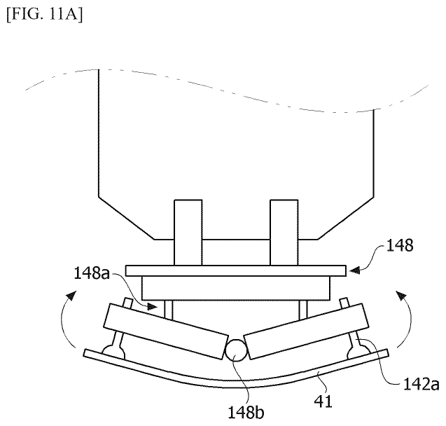

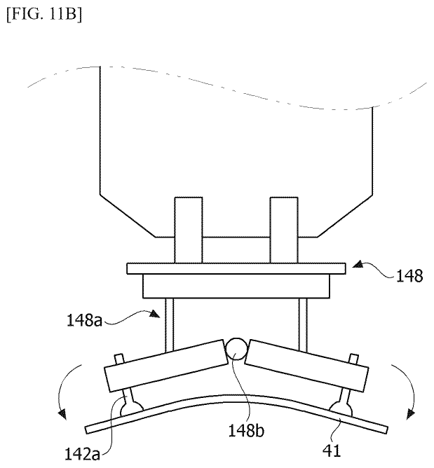

FIG. 10 is a view illustrating a first-first pick-up unit according to another embodiment. FIGS. 11A and 11B are views illustrating a process in which the electrode plate is bent as the sucking part of the first-first pick-up unit is tilted.

With reference to FIG. 10, the body part 141 may include a first body part 141a on which the plurality of sucking parts 142a are disposed, and a second body part 141b on which the plurality of sucking parts 142a are disposed, and a rotary member 148b may be coupled between the first body part 141a and the second body part 141b.

A vibration part 148 may rotate the first body part 141a and the second body part 141b in the opposite directions. The vibration part 148 may have pressing parts 148a respectively connected to the first body part 141a and the second body part 141b. The pressing part 148a may be retracted or extended by a motor or a cylinder. However, the present invention is not necessarily limited thereto. All various rotational structures may be applied as the structure for rotating the first body part 141a and the second body part 141b.

With reference to FIG. 11A, when the pressing parts 148a are retracted, an outer side of the first body part 141a and an outer side of the second body part 141b are rotated in the opposite directions. In this case, the rotary member 148b may be rotatably coupled to an inner side of the first body part 141a and an inner side of the second body part 141b.

With this configuration, the sucking part 142a disposed on the first body part 141a and the sucking part 142a disposed on the second body part 141b are tilted, the picked-up positive electrode plate 41 is bent so that two opposite ends of the positive electrode plate 41 are directed upward.

On the contrary, as illustrated in FIG. 11B, when the pressing parts 148a are extended, the outer side of the first body part 141a and the outer side of the second body part 141b are rotated in the opposite directions. Therefore, the positive electrode plate 41 is bent so that two opposite ends of the positive electrode plate 41 are directed downward. In case that this tilting operation is quickly performed, the positive electrode plate attached to the lower portion of another positive electrode plate may be separated.

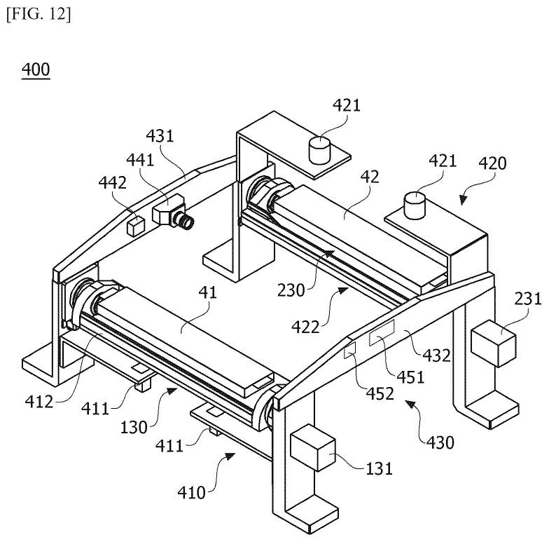

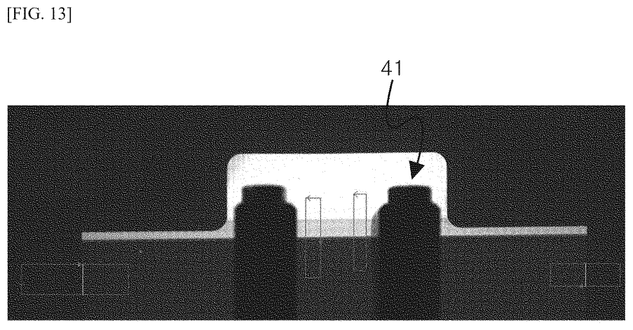

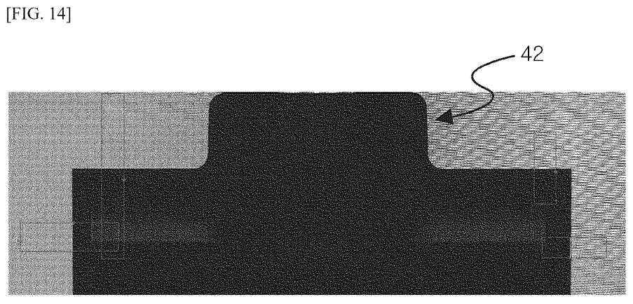

FIG. 12 is a view illustrating an inspection unit according to the embodiment. FIG. 13 is an image of a positive electrode plate disposed on the first alignment stage. FIG. 14 is an image of a negative electrode plate disposed on the second alignment stage.

With reference to FIG. 12, an inspection module 400 may include a positive electrode plate inspection unit 410, a negative electrode plate inspection unit 420, and a stacking inspection unit. The positive electrode plate inspection unit 410 may inspect whether the positive electrode plate 41 is aligned on the first alignment stage 130. The positive electrode plate 41 needs to be aligned on the first alignment stage 130 so that the stacking head may accurately pick up the positive electrode plate 41.

When the inspection result indicates that the positive electrode plate is not aligned, a first alignment unit (not illustrated) disposed below the first alignment stage 130 may finely move the first alignment stage 130 so that the positive electrode plate is disposed at an aligned position.

The negative electrode plate inspection unit 420 may inspect whether the negative electrode plate 42 is aligned on the second alignment stage 230. The negative electrode plate 42 needs to be aligned on the second alignment stage 230 so that the stacking head may accurately pick up the negative electrode plate 42.

When the inspection result indicates that the negative electrode plate is not aligned, a second alignment unit (not illustrated) disposed below the second alignment stage 230 may finely move the second alignment stage 230 so that the negative electrode plate is disposed at an aligned position.

The stacking inspection unit may inspect whether the positive electrode plate 41 and the negative electrode plate 42 stacked on the stacking stage 320 are aligned.

The positive electrode plate inspection unit 410 may include a first lighting part 412 and first cameras 411 disposed below the first alignment stage 130. The first lighting part 412 may include a flat dome structure in order to uniformly irradiate the positive electrode plate 41 with light at various angles. However, various lighting structures, which emit light so that the first camera may easily inspect the positive electrode plate 41, may be applied as the first lighting part 412. According to the embodiment, the first camera 411 is disposed below the first alignment stage 130 and captures an image of the positive electrode plate 41, such that irregular reflection may be reduced, and a clear image may be acquired.

The negative electrode plate inspection unit 420 may include a second lighting part 422 and second cameras 421 disposed above the second alignment stage 230. The second lighting part 422 may include a back light structure configured to emit light from below the negative electrode plate 42. However, various lighting structures, which emit light so that the second camera 421 may easily inspect the negative electrode plate 42, may be applied as the second lighting part 422. According to the embodiment, the second lighting part 422 emits light to a lower portion of the negative electrode plate 42, and the second camera 421 is disposed above the second alignment stage 230 and captures an image of the negative electrode plate 42, such that irregular reflection may be reduced, and a clear image may be acquired.

According to the embodiment, the first camera 411 configured to capture an image of the positive electrode plate 41 may be disposed below the positive electrode plate 41, whereas the second camera 421 configured to capture an image of the negative electrode plate 42 may be disposed above the negative electrode plate 42. With this structure, a lower space of the second alignment stage 230 may be utilized. Therefore, as described below, the pulling module 600 may approach the lower space of the second alignment stage 230 and hold the electrode assembly disposed on the stacking stage 320.

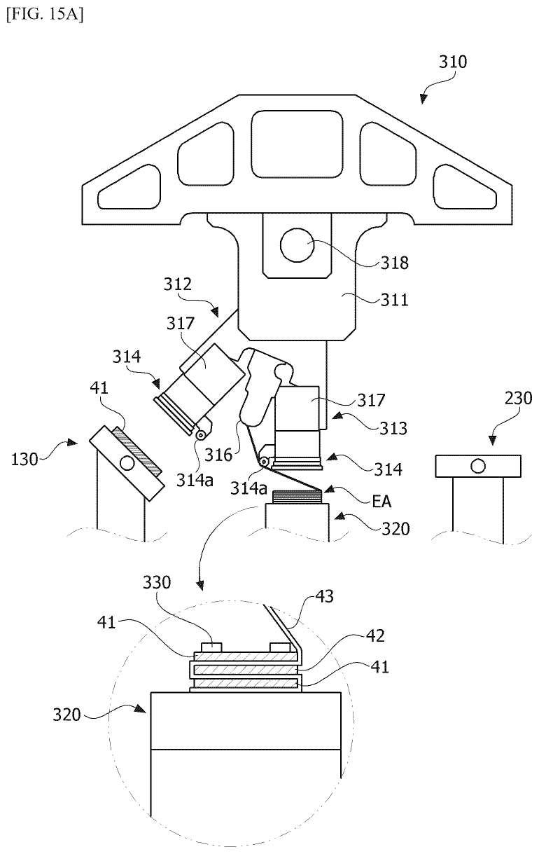

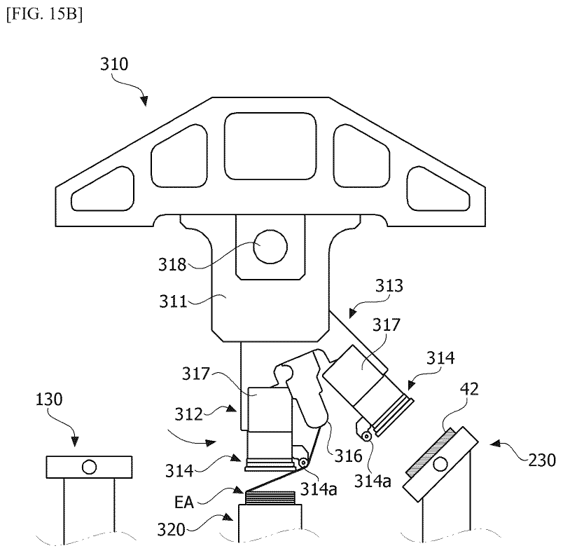

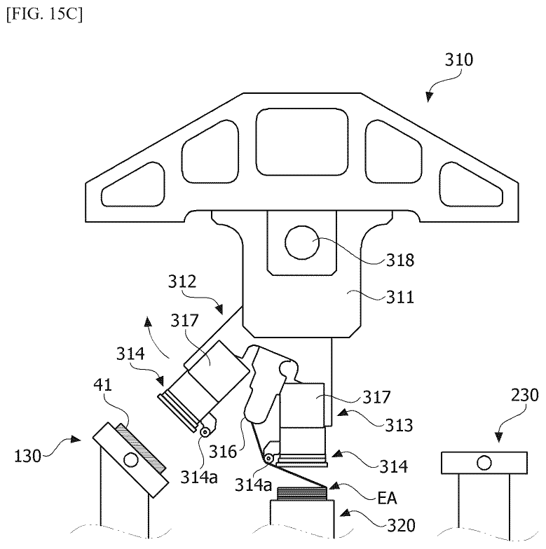

FIGS. 15A to 15C are views illustrating a process in which a positive electrode plate, a negative electrode plate, and a separator are stacked on the stacking stage by the stacking head.

With reference to FIG. 15A, the stacking head 310 may include a first head part 312 configured to rotate to face the first alignment stage 130 and pick up the positive electrode plate 41, a second head part 313 configured to rotate to face the second alignment stage 230 and pick up the negative electrode plate 42, a head rotation part 318 configured to rotate the first head part 312 and the second head part 313, and a feeding roller 316 disposed between the first head part 312 and the second head part 313 and configured to provide the separator 43.

The first head part 312 and the second head part 313 may be disposed to be inclined at predetermined angles. For example, the first head part 312 and the second head part 313 may be disposed to be inclined at an angle of 45 degrees. However, the present invention is not necessarily limited thereto. The first head part 312 and the second head part 313 may be disposed to be inclined at various angles. Angles of the first alignment stage and the second alignment stage may also be adjusted in accordance with the inclination angles of the first head part 312 and the second head part 313.

The first head part 312 and the second head part 313 may each have a third pick-up unit 314 capable of sucking the electrode plate. The third pick-up unit 314 may move upward or downward in a longitudinal direction (Z-axis direction) of the head part and pick up the electrode plates disposed on the first and second alignment stages 130 and 230. According to the embodiment, the third pick-up units 314 may move upward or downward independently of the rotations of the first head part 312 and the second head part 313.

The feeding roller 316 disposed between the first head part 312 and the second head part 313 may continuously supply the separator 43. According to the embodiment, because the feeding roller 316 is disposed between the first head part 312 and the second head part 313, the first head part 312 and the second head part 313 may serve as shields. Therefore, even though the first head part 312 and the second head part 313 are rotated, airflow resistance applied to the separator 43 may be minimized.

The third pick-up units 314 may include auxiliary rollers 314a configured to guide the separator 43. The auxiliary rollers 314a respectively disposed on the first head part 312 and the second head part 313 may be disposed to face each other.

A plurality of support units 330 disposed adjacent to the stacking stage 320 may press and fix two opposite portions of the positive electrode plate 41, two opposite portions of the negative electrode plate 42, and two opposite portions of the separator 43.

The plurality of support units 330 may move horizontally to the inside and outside of the stacking stage 320. The plurality of support units 330 may move to the outside of the stacking stage 320 so as not to hinder the stacking process while the positive electrode plate 41, the negative electrode plate 42, and the separator 43 are stacked.

When the positive electrode plate 41, the negative electrode plate 42, and the separator 43 are stacked on the top surface of the stacking stage 320, the plurality of support units 330 may move to the inside of the stacking stage 320, move downward, and then press the positive electrode plate 41, the negative electrode plate 42, and the separator 43.

With reference to FIG. 15B, the first head part 312 may be rotated in a first rotation direction by the head rotation part 318 and disposed above the stacking stage 320. The first head part 312 may stack the picked-up positive electrode plate 41 on the stacking stage 320. The first rotation direction may be a counterclockwise direction. However, the present invention is not necessarily limited thereto. The first rotation direction may be a clockwise direction.

In this case, all the plurality of support units 330, which have pressed the separator 43, may move to the outside of the stacking stage 320, thereby preventing interference. Thereafter, when the positive electrode plate 41 is disposed on the separator 43, the plurality of support units 330 may move to an upper side of the positive electrode plate 41 and support the positive electrode plate 41.

With reference to FIG. 15C, the second head part 313 may be rotated in a second rotation direction by the head rotation part 318 and disposed above the stacking stage 320. The second rotation direction may be a clockwise direction. However, the present invention is not necessarily limited thereto. The second rotation direction may be a counterclockwise direction.

The second head part 313 may stack the picked-up negative electrode plate 42 on the stacking stage 320. In this case, all the plurality of support units 330, which have pressed the separator 43, may move to the outside of the stacking stage 320, thereby preventing interference. Thereafter, when the negative electrode plate 42 is disposed on the separator 43, the plurality of support units 330 may move to an upper side of the negative electrode plate 42 again and support the negative electrode plate 42.

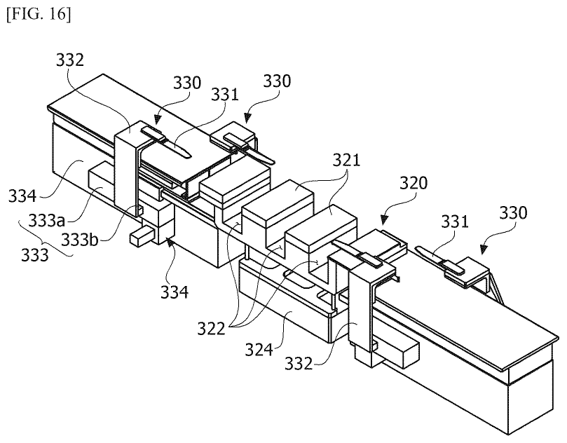

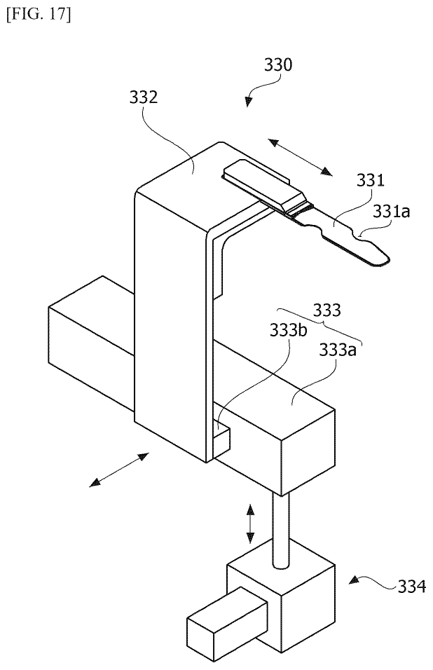

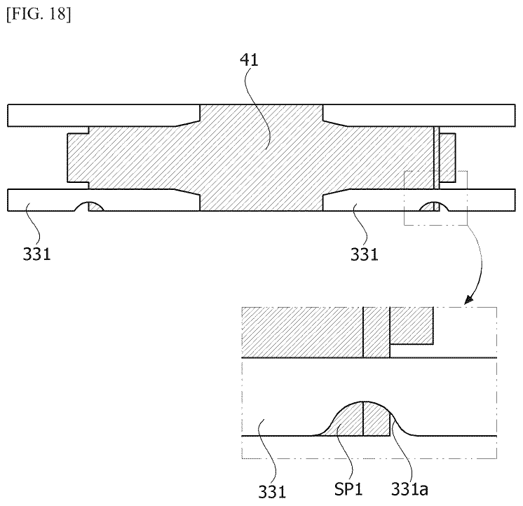

FIG. 16 is a view illustrating the stacking stage and the plurality of support units according to the embodiment. FIG. 17 is a view illustrating a three-axis operation of the support unit. FIG. 18 is a view illustrating a state in which the plurality of support units press the electrode plate.

With reference to FIG. 16, the stacking stage 320 may have a plurality of slits 322. Therefore, the stacking stage 320 may support the plurality of electrode plates on protruding support parts 321 disposed between the plurality of slits 322. Thereafter, pincer parts 610 of the pulling module 600 may be inserted through the plurality of slits 322.

A stage driving part 324 may be disposed at a lower side of the stacking stage 320 and move the stacking stage 320 upward or downward. With this configuration, the stacking stage 320 may maintain a constant height of the electrode plate disposed at the uppermost side even though the plurality of electrode plates are disposed.

According to the embodiment, the stacking stage 320 may be manufactured to be fixed without moving, thereby preventing the stacked electrodes from being misaligned. However, the present invention is not necessarily limited thereto. A driving part configured to operate the stacking stage 320 along the X-axis and the Y-axis for implementing alignment may be additionally disposed.

With reference to FIGS. 17 and 18, the plurality of support units 330 may press and support the positive electrode plate 41, the negative electrode plate 42, and the separator 43. The plurality of support units 330 may each include a support pin 331 configured to press the positive electrode plate 41, the negative electrode plate 42, and the separator 43, a first support driving part 333 configured to move the support pin 331 in the horizontal direction, and a second support driving part 333 configured to move the support pin 331 in the vertical direction. The support pin 331 may be attached to a connection member 332 connected to the first support driving part 333 and move together with the connection member 332.

The first support driving part 333 and the second support driving part 333 may operate independently of each other. Therefore, the support pin 331 may be quickly moved onto or away from the stacking stage 320. For example, the support pin 331 may be moved horizontally by the first support driving part 333 in a state in which a vertical height of the support pin 331 is maintained by the second support driving part 333. Alternatively, the support pin 331 may be moved vertically upward by the second support driving part 333 at the same time when the support pin 331 is moved horizontally by the first support driving part 333.

In case that a vertical operation part and a horizontal operation part are connected to each other, the horizontal movement needs to be performed after the vertical movement is completed, or the vertical movement needs to be performed after the horizontal movement is completed, such that the vertical movement and the horizontal movement are implemented. For this reason, there is a problem in that a time delay occurs.

The first support driving part 333 may include a first-first support driving part 333a configured to move the support pin 331 in the first direction, and a first-second support driving part 333b configured to move the support pin 331 in the second direction perpendicular to the first direction. The first-first support driving part 333a and the first-second support driving part 333b may also operate independently. According to the embodiment, because the support pin operates independently along the two axes or the three axes, the electrode assembly may be quickly pressed or released, such that the TAC time may be reduced.

At least one hole 331a may be formed in the support pin 331. An image-capturing exposure region SP1 may be formed by the hole 331a, and an edge region of the electrode assembly may be exposed when the support pin 331 presses any one of the positive electrode plate, the negative electrode plate, and the separator that constitute the electrode assembly. Therefore, even in a state in which the electrode assembly is pressed by the support pin, an image of the edge region of the electrode assembly may be captured, such that whether the electrode assembly is aligned may be accurately determined.

The hole 331a may be formed only in some of the plurality of support pins 331. However, the present invention is not necessarily limited thereto. The holes 331a may be formed in all the support pins 331.

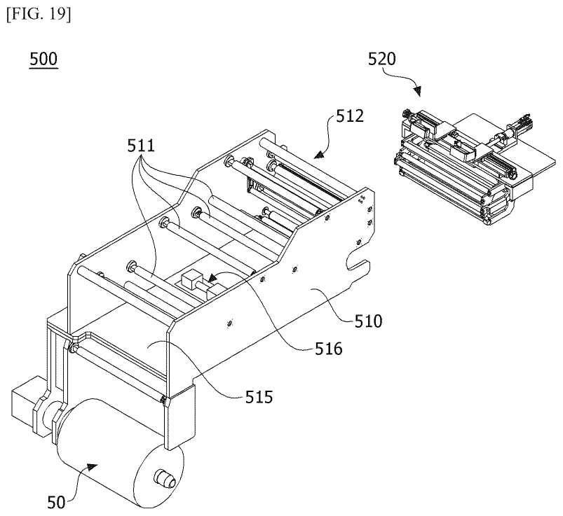

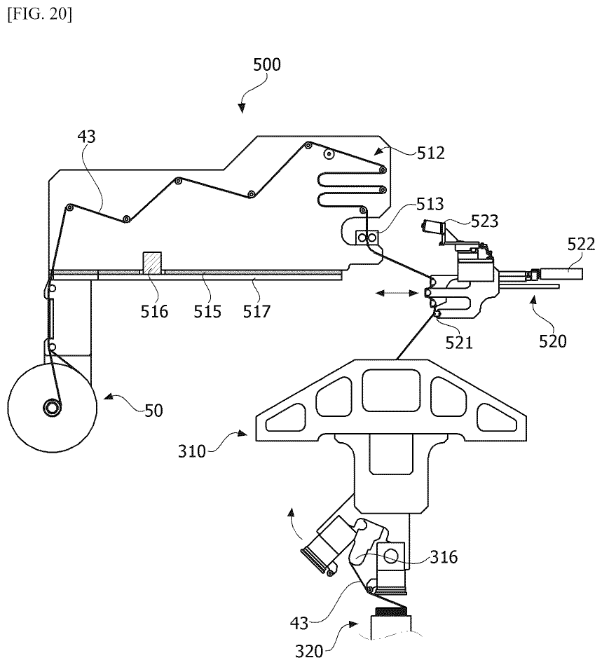

FIG. 19 is a view illustrating the separator supply module according to the embodiment. FIG. 20 is a view illustrating a state in which tension of the separator is adjusted by the separator supply module according to the embodiment.

With reference to FIGS. 19 and 20, the separator supply module 500 may include an unwinder 50 around which the wound separator is disposed, a plurality of rollers 511 configured to provide the separator 43, a plurality of length adjustment rollers 512, main supply rollers 513, and a pair of sidewalls 510 configured to support two opposite ends of each of the rollers.

The separator supply module 500 may include a meandering adjustment part 516 configured to prevent meandering that refers to a phenomenon in which the separator moves obliquely leftward and rightward when the separator is supplied. A first structure plate 515 and the sidewalls 510 are moved on a second structure plate 517 by the meandering adjustment part 516, such that a direction of the separator 43 wound around the plurality of rollers 511 may be adjusted. Various driving members, such as a motor, which adjusts relative positions of the first structure plate 515 and the second structure plate 517, may be used as the meandering adjustment part 516. However, the present invention is not necessarily limited thereto. Various publicly-known structures capable of preventing the meandering of the separator may be applied as the meandering adjustment part without limitation.

The separator 43 supplied through the separator supply module 500 may be supplied onto the stacking stage 320 by means of the feeding roller 316 of the stacking head 310.

In this case, the tension of the separator 43 may be instantaneously loosened during the rotation of the stacking head 310, and the separator 43 may be unevenly disposed on the electrode plate. In order to prevent this situation, a tension adjustment module 520 may be disposed between the separator supply module 500 and the feeding roller 316 of the stacking head 310.

When the tension of the separator 43 is loosened for various reasons, the tension adjustment module 520 may move to a portion between the separator supply module 500 and the feeding roller 316 and adjust the tension of the separator 43. Therefore, the tension of the separator 43 supplied by means of the feeding roller 316 may be maintained, which may prevent a stacking defect.

The tension adjustment module 520 may include a plurality of tension rollers 521 configured to guide the separator, and a roller driving part 522 configured to move the tension rollers 521 forward toward or rearward from the separator supply module 500.

In addition, the tension adjustment module 520 may further include a detection sensor 523 configured to detect the tension of the separator. In order to prevent the tension of the separator from being loosened, the tension adjustment module 520 may apply the tension to the separator by moving the tension rollers 521 rearward. On the contrary, the roller driving part 522 may control and decrease the tension of the separator by moving the tension rollers 521 forward.

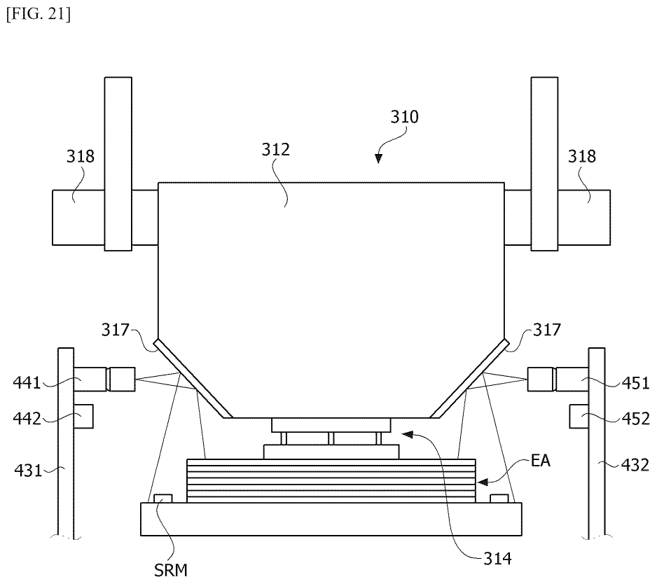

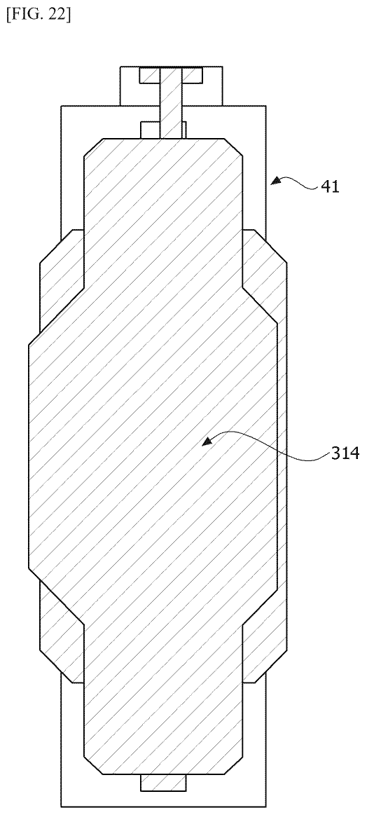

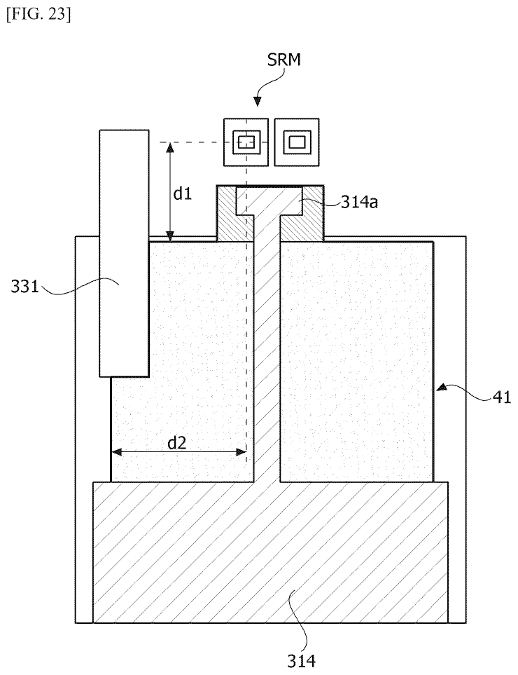

FIG. 21 is a view illustrating a process of inspecting alignment of an electrode assembly stacked on the stacking stage. FIG. 22 is a top plan view illustrating a state in which a positive electrode plate is sucked by a third pick-up module. FIG. 23 is a view illustrating a process of determining whether a positive electrode plate is aligned on the basis of a captured image of the positive electrode plate.

With reference to FIGS. 12, 15C, and 21, the stacking inspection unit may include a third camera 441 and a fourth camera 451 disposed on a first frame 431 and a second frame 432 that connect the first alignment stage 130 and the second alignment stage 230. In addition, the stacking inspection unit may further include a third lighting part 442 and a fourth lighting part 452.

Reflective mirrors 317 may be respectively disposed on the first head part 312 and the second head part 313 of the stacking head 310. The third camera 441 disposed on the first frame 431 and the fourth camera 451 disposed on the second frame 432 may capture planar images of the electrode assembly EA reflected by the reflective mirrors 317. For example, the third camera 441 may capture an image of one end of the electrode assembly EA, and the fourth camera 451 may capture an image of the other end of the electrode assembly EA.

Because the stacking head 310 is disposed above the stacking stage 320, the camera may be disposed obliquely to prevent interference with the stacking head 310, and the camera may capture an image of the electrode assembly EA. However, in this case, because only images of the electrode assembly EA disposed obliquely may be captured, there is a problem in that it is difficult to accurately measure whether the electrode assembly EA is aligned. In contrast, according to the embodiment, images of the plurality of electrode plates stacked vertically may be captured, such that it is possible to accurately measure whether the plurality of electrode plates are aligned.

With reference to FIGS. 22 and 23, whether the stacked electrode plates are aligned may be determined by calculating distances d1 and d2 between a reference mark SRM and an outer surface of the electrode plate on the basis of the image of the stacked electrode plates. According to the embodiment, because images are acquired by means of the reflective mirrors 317 disposed on the first head part 312 and the second head part 313 of the stacking head 310, positions in the image may vary depending on the tolerance of the reflective mirror. Therefore, whether the electrode plate is aligned may be determined by measuring an interval based on the reference mark SRM.

Various image processing techniques in the related art may be applied as the method of determining whether the electrode plate is aligned. For example, whether the electrode plate is aligned may be determined depending on whether a distance or area from an outer side of the electrode plate to a particular point satisfies a predetermined range.

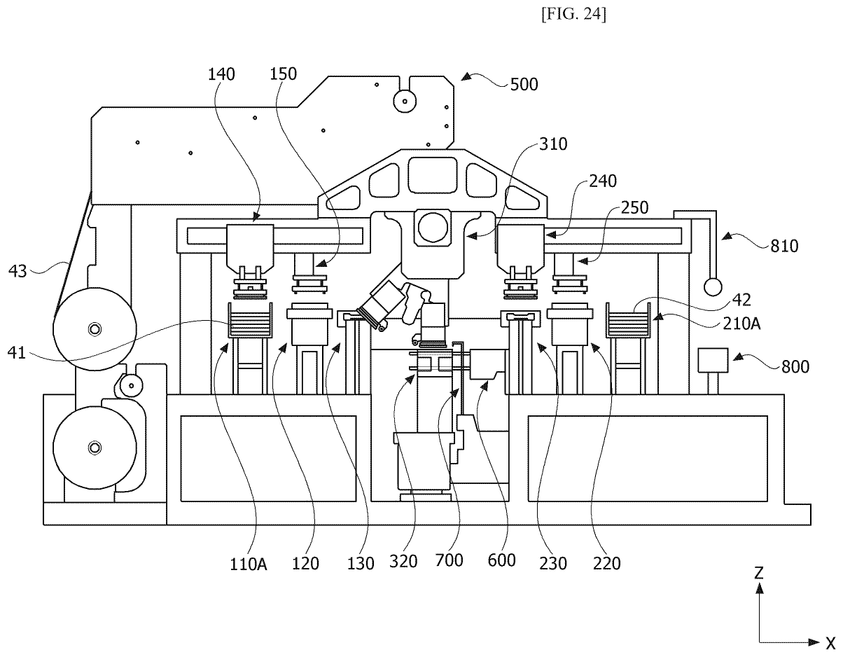

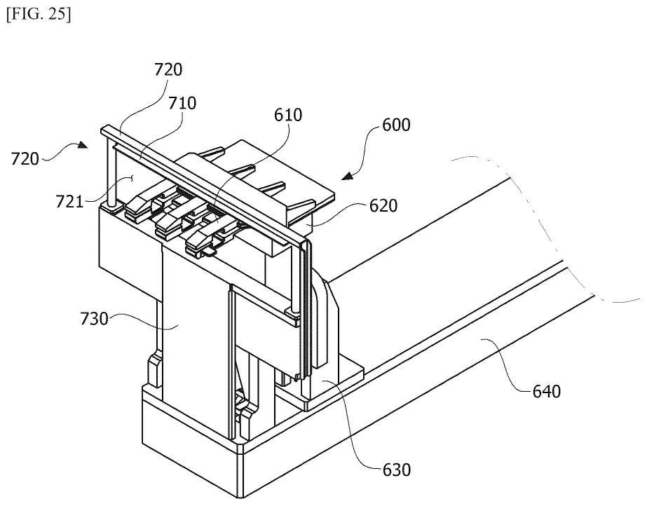

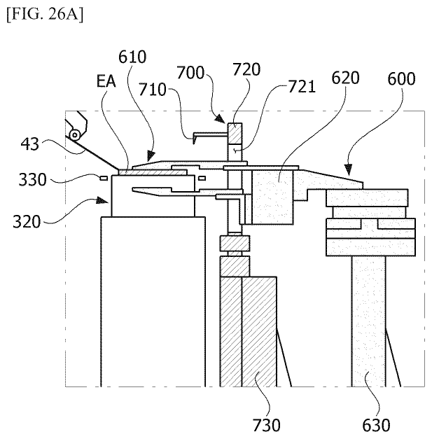

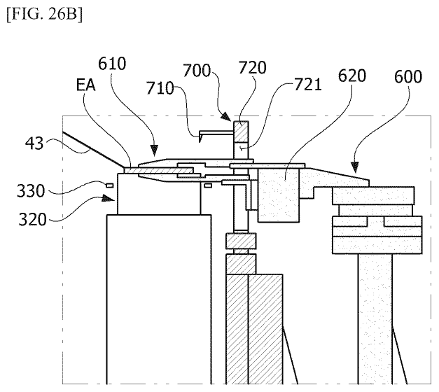

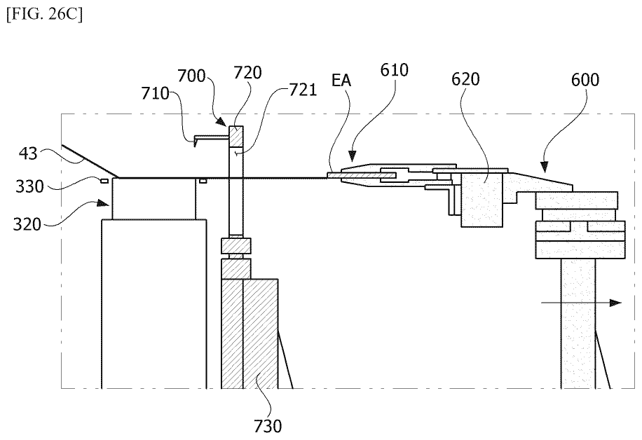

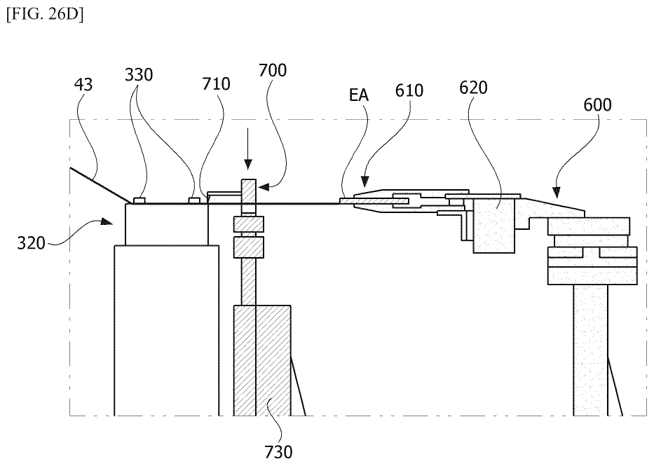

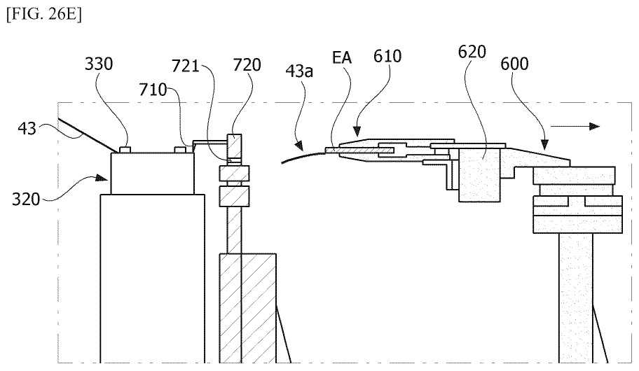

FIG. 24 is a view illustrating a state in which the pulling module of the stacking apparatus according to the embodiment approaches an electrode assembly. FIG. 25 is a perspective view illustrating the cutting module and the pulling module. FIGS. 26A to 26E are views illustrating states in which the pulling module extracts an electrode assembly rearward.

With reference to FIGS. 24, 25, and 26A, when the electrode assembly EA is completely manufactured, the pulling module 600 may approach a lower space of the negative electrode plate inspection unit and hold the electrode assembly EA disposed on the stacking stage 320. A rail 640 along which the pulling module 600 moves may be disposed below the negative electrode plate inspection unit.

The cutting module 700 may be disposed between the stacking stage 320 and the pulling module 600. An opening hole 721, through which the pincer parts 610 of the pulling module 600 may pass, may be formed in the cutting module 700. Therefore, the pulling module 600 may pass through the cutting module 700 and approach the stacking stage 320.

With reference to FIGS. 26B and 26C, a pincer driving part 620 may decrease an interval between the pincer parts 610 so that the pincer parts 610 may hold the electrode assembly EA. A pincer movement part 630 may move the pincer parts 610 rearward in the state in which the pincer parts 610 hold the electrode assembly EA. During this process, the separator 43 may be continuously supplied. The plurality of support units 330 may move to the outside of the stacking stage 320, so that the separator 43 may be continuously supplied.

With reference to FIGS. 26D and 26E, when the pulling module 600 moves rearward to a predetermined position, the cutting module 700 may move downward and cut the separator 43. The cutting module 700 may include a cutter 710 configured to cut the separator 43, a cutter support part 720 configured to support the cutter 710, and a cutter driving part 730 configured to move the cutter support part 720 upward or downward. As described above, the opening hole 721, through which the pincer parts 610 of the pulling module 600 may pass, may be formed in the cutter support part 720.

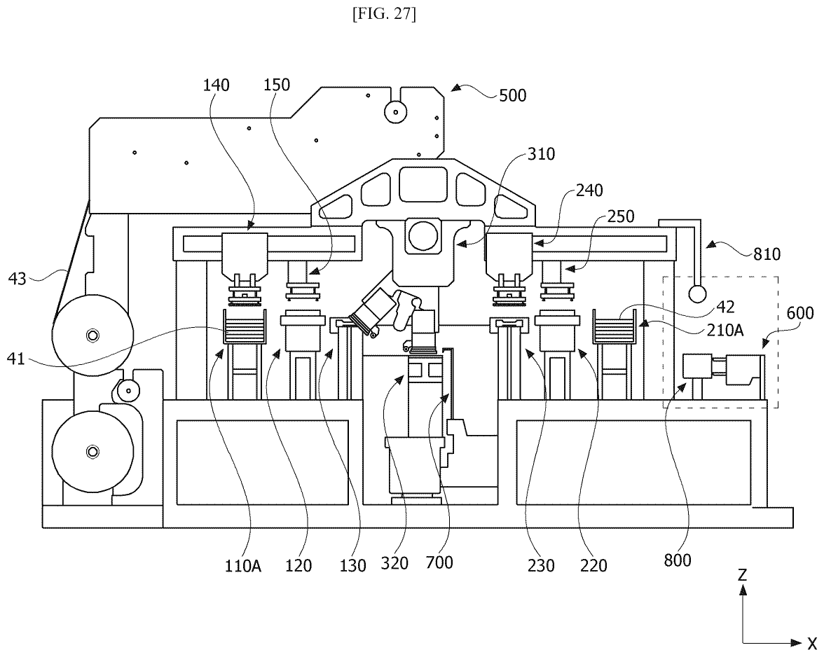

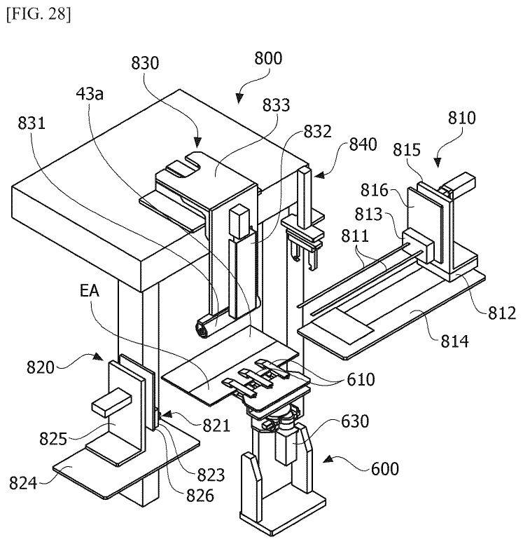

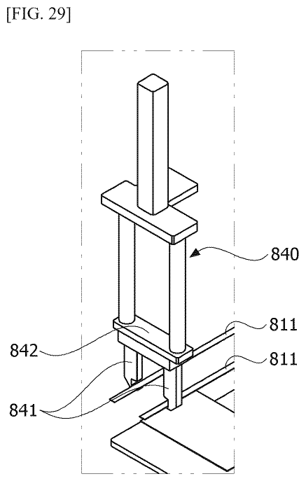

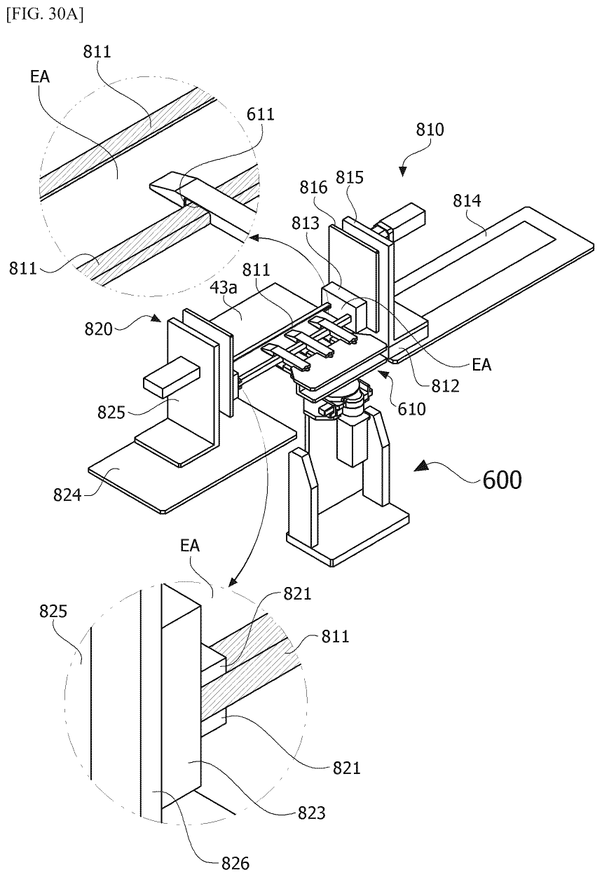

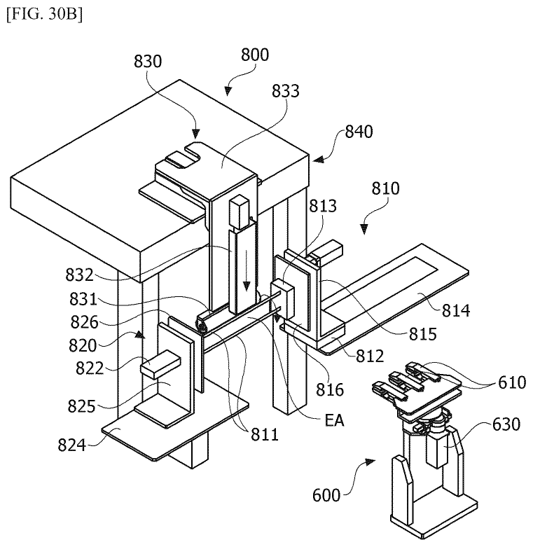

FIG. 27 is a view illustrating a state in which an electrode assembly is moved to one side of the stacking apparatus by the pulling module according to the embodiment. FIG. 28 is a view illustrating the winding module according to the embodiment. FIG. 29 is a view illustrating a state in which a guide bar is supported by a hook of a clamping unit. FIG. 30A is a view illustrating a state in which an electrode assembly is fitted with the guide bar of the winding module. FIG. 30B is a view illustrating a state in which a separator of an electrode assembly is wound as first and second rotation parts of the winding module are rotated.

With reference to FIGS. 27 and 28, the pulling module 600 may move to the finishing region WA provided at one side of the stacking apparatus in the state in which the pulling module 600 holds the electrode assembly EA. The finishing region WA refers to a region in which the cut separator 43 is wound around and fixed to the electrode assembly EA.

The winding module 800 may include a first rotation unit 810 including a pair of guide bars 811 configured to fix two opposite ends of the electrode assembly EA, a second rotation unit 820 configured to fix ends of the pair of guide bars 811, and a brush unit 830 configured to fix a cutting part 43a of the separator 43 to the electrode assembly EA when the electrode assembly EA rotates.

The first rotation unit 810 may include a first plate 814, a sliding part 812 configured to slide on the first plate 814, a first support plate 815 disposed on the sliding part 812, a first rotation part 813 disposed on the first support plate 815, and the pair of guide bars 811 connected to the first rotation part 813. In addition, the first rotation unit may include a first guide driving part 816 configured to operate the first rotation part 813 upward, downward, leftward, or rightward on the first support plate 815.

The pair of guide bars 811 may be elongated to entirely support two opposite surfaces of the electrode assembly EA. If different guide bars hold two opposite ends of the electrode assembly and rotate, a serious crease may be formed in case that rotation centers of the guide bars disposed at the two opposite ends are not consistent with each other. However, according to the embodiment, because the pair of guide bars 811 entirely support two opposite surfaces of the electrode assembly EA, it is possible to prevent the separator 43 of the electrode assembly EA from creasing.

The pair of guide bars 811 for the electrode assembly may each have a plate shape or a bent shape. In case that pair of guide bars 811 each have a plate shape, the guide bar may be divided into two pieces to support a top surface and a bottom surface of the electrode assembly. In case that pair of guide bars 811 each have a bent shape, the two guide bars 811 may respectively support lateral surfaces of the electrode assembly.

The second rotation unit 820 may include a second plate 824, a second support plate 825 disposed on the second plate 824, a second rotation part 823 disposed on the second support plate 825, and a holder 821 disposed on the second rotation part 823 and configured such that the pair of guide bars 811 are coupled to the holder 821. In addition, the second rotation unit may include a second guide driving part 826 configured to operate the second rotation part 823 upward, downward, leftward, or rightward on the second support plate 825.

The brush unit 830 may include a brush 831, a brush driving part 832 configured to operate the brush 831 upward or downward, and a fixing part 833 configured to fix the brush driving part 832.

When the pulling module 600 moves to the finishing region in the state in which the pulling module 600 holds the electrode assembly EA, the sliding part 812 of the first rotation unit 810 may slide on the first plate toward the electrode assembly EA.

With reference to FIG. 29, because the pair of guide bars 811 are formed to be relatively long, the pair of guide bars 811 may move in a state of being mounted on a clamp unit 840 and be accurately fitted with a lateral surface of the electrode assembly EA. In this case, positions or heights of the pair of guide bars 811 may be adjusted by the first guide driving part 816 so that the pair of guide bars 811 may be appropriately fitted with the lateral surface of the electrode assembly EA.

The clamp unit 840 may include hooks 841 configured to fix the pair of guide bars 811. The clamp unit 840 may move upward, downward, leftward, or rightward to fix the pair of guide bars 811. Therefore, the clamp unit 840 may be separated and moved away from the pair of guide bars 811 when the pair of guide bars 811 are coupled to the electrode assembly EA. To this end, a width adjustment part 842 for adjusting widths of the pair of hooks 841 may be further provided.

With reference to FIG. 30A, when the first rotation unit 810 moves toward the second rotation unit 820, the pair of guide bars 811 may be fitted with and support two opposite surfaces of the electrode assembly EA. In this case, the pair of guide bars 811 are illustrated as being bent and respectively supporting the two opposite surfaces of the electrode assembly EA.

In this case, a guide groove 611, through which the pair of guide bars 811 may pass, may be formed in the pincer part 610 of the pulling module 600 that holds the electrode assembly EA. Therefore, the pair of guide bars 811 may pass through the guide groove 611 of the pincer part 610 and be coupled to the end of the electrode assembly EA.

The pair of guide bars 811 coupled to the end of the electrode assembly EA may be fixed to the holder 821 of the second rotation unit 820.

With reference to FIG. 30B, when the first rotation part 813 of the first rotation unit 810 and the second rotation part 823 of the second rotation unit 820 are rotated, the electrode assembly EA is also rotated. Therefore, the cutting part 43a of the separator 43, which is not yet wound around the electrode assembly EA, is wound around the electrode assembly EA.

When the electrode assembly EA is coupled to the first rotation unit 810 and rotated, the brush unit 830 may move the brush 831 downward. The brush 831 may be a cylindrical roller. However, the present invention is not necessarily limited thereto. The brush 831 may guide the cutting part 43a of the separator 43 so that the cutting part 43a of the separator 43 is wound around the electrode assembly EA when the electrode assembly EA rotates.

Although not illustrated, a bonding agent may be applied onto the separator 43 by a separate bonding agent application unit. Therefore, the cutting part 43a of the separator 43 wound around the electrode assembly EA may be bonded to the electrode assembly EA. According to the embodiment, the cutting part 43a of the separator 43 may be automatically wound around and fixed to the electrode assembly EA. However, the bonding agent application unit may be excluded in case that the separator has a bonding component.

When the finishing process is completed, the first rotation unit 810 may move in a direction away from the second rotation unit 820. Because the pair of guide bars 811 each have a plate shape, the electrode assembly EA may be easily separated even in the state in which the separator 43 is wound during the winding process.

Thereafter, the pulling module 600 may hold the electrode assembly EA again and transport the electrode assembly EA to the guide rail along which the heating module 20 is transferred. However, the present invention is not necessarily limited thereto. The electrode assembly EA may be transferred to the heating module 20 by a separate transfer unit.

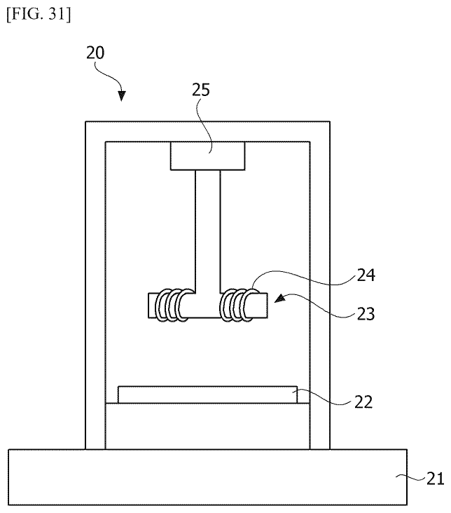

FIG. 31 is a view illustrating the heating module of one embodiment.

The heating module 20 according to the embodiment may include a seating plate 22 on which the electrode assembly EA is seated, and a high-frequency induction heating part 23 configured to generate heat by applying high frequency waves. The high-frequency induction heating part 23 may include a plurality of coils 24. In addition, a coil lifting part 25 configured to move the high-frequency induction heating part upward or downward may be further included.

The high-frequency induction heating refers to a method that generates an eddy current in the vicinity of a surface of the metal conductor by applying high-frequency waves to the metal conductor and heats the metal conductor by using a phenomenon in which a loss of electric power caused by the eddy current is converted into a thermal loss.

The high-frequency induction heating is advantageous in heating the metal in a non-contact manner. That is, because a current collector present in the electrode assembly EA may be heated directly, a plurality of heating points are positioned in the entire electrode assembly EA, such that a thermal conduction section is shortened, and a temperature deviation is reduced. Because a temperature deviation in the electrode assembly EA is reduced, it is not necessary to excessively apply heat to raise a temperature to a temperature required for thermal bonding, which consequently improves energy efficiency.

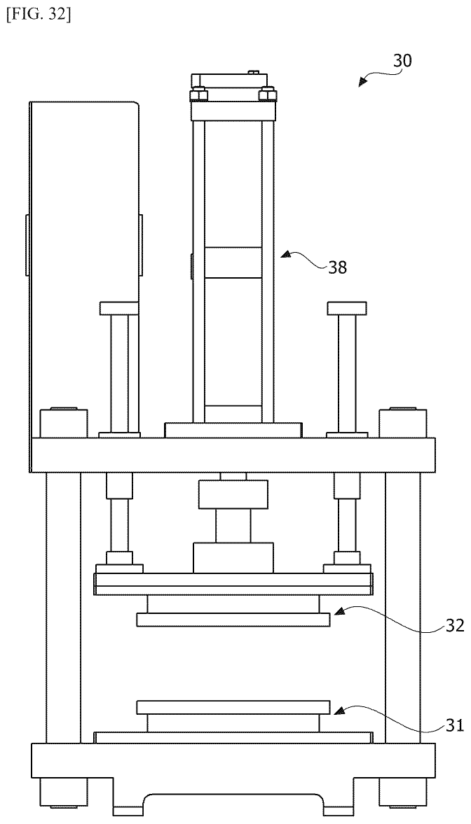

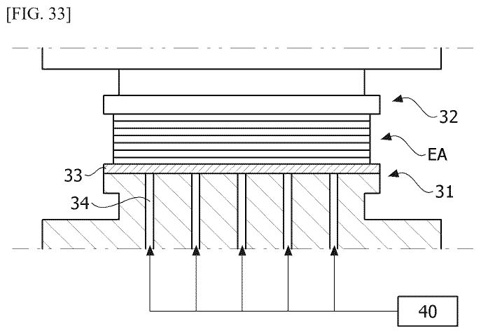

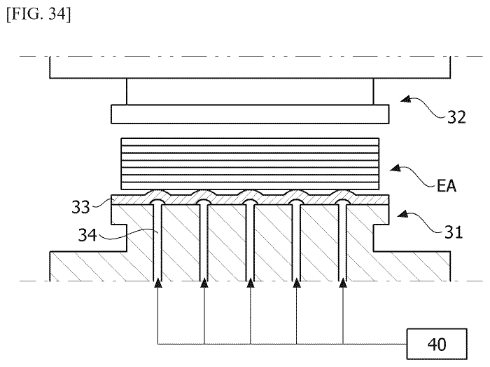

FIG. 32 is a view illustrating the pressing module of one embodiment. FIG. 33 is a view illustrating a diaphragm disposed on a lower pressing plate. FIG. 34 is a view illustrating a state in which an electrode assembly and the lower pressing plate are separated as the diaphragm on the lower pressing plate expands.

With reference to FIG. 32, the pressing module 30 may include a lower pressing plate 31, an upper pressing plate 32, and a pressing plate driving part 38 configured to move the upper pressing plate 32 upward or downward.

When the electrode assembly EA is transferred to the lower pressing plate 31, the pressing plate driving part 38 may move the upper pressing plate 32 downward to press the electrode assembly EA. During this process, the positive electrode plate, the negative electrode plate, and the separator may be joined to one another.

With reference to FIGS. 33 and 34, a plurality of first through-lines 34 may be formed in the lower pressing plate 31, and a first diaphragm 33 may be disposed on an upper portion of the lower pressing plate 31.

The first through-lines 34 are connected to an external pump 40. When air or fluid is introduced, the first diaphragm 33 expands in a region connected to the first through-lines 34. Therefore, with the expansion region of the first diaphragm 33, a contact area between the first diaphragm 33 and the electrode assembly EA is decreased. Therefore, the lower pressing plate 31 and the electrode assembly EA are easily separated.

According to the embodiment, the air or fluid may be simultaneously or sequentially introduced into the plurality of first through-lines 34.

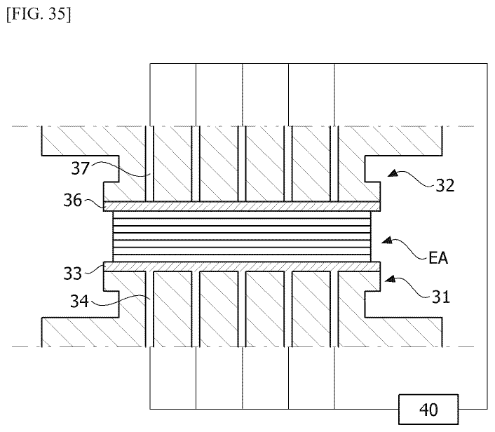

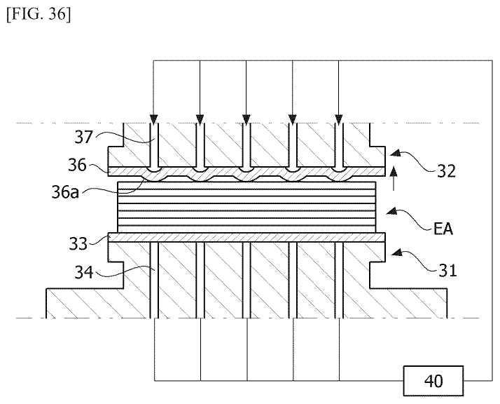

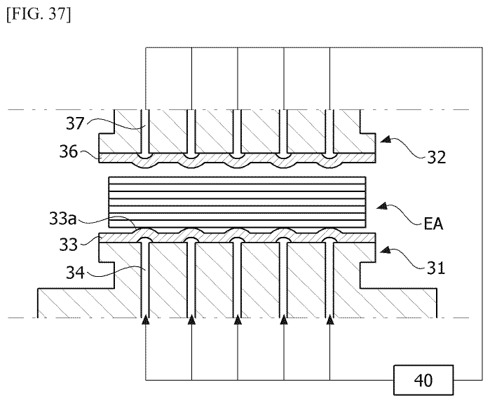

FIG. 35 is a view illustrating a state in which the diaphragm is disposed on the lower pressing plate and the upper pressing plate. FIG. 36 is a view illustrating a state in which an electrode assembly and the upper pressing plate are separated as the diaphragm on the upper pressing plate expands. FIG. 37 is a view illustrating a state in which an electrode assembly and the lower pressing plate are separated as the diaphragm on the lower pressing plate expands.

With reference to FIG. 35, a plurality of second through-lines 37 may also be formed in the upper pressing plate 32, and a second diaphragm 36 may be disposed on a lower portion of the upper pressing plate 32. The second through-lines 37 are connected to the external pump. When air or fluid is introduced, the second diaphragm 36 connected to the second through-lines 37 may expand.

With reference to FIG. 36, when the pressing is completed, the upper pressing plate 32 moves upward, and simultaneously, the air or fluid is introduced through the plurality of second through-lines 37, such that the second diaphragm 36 may expand. With the expansion region 36a of the second diaphragm 36, a contact area between the second diaphragm 36 and the electrode assembly EA is decreased. Therefore, the upper pressing plate 32 and the electrode assembly EA are easily separated.

Thereafter, when the upper pressing plate 32 moves upward, the first diaphragm 33 expands in the region connected to the first through-line 34, as illustrated in FIG. 37. Therefore, with the expansion region 33a of the first diaphragm 33, a contact area between the first diaphragm 33 and the electrode assembly EA is decreased. Therefore, the lower pressing plate 31 and the electrode assembly EA are easily separated.

However, the present invention is not necessarily limited thereto. The first diaphragm 33 and the second diaphragm 36 may simultaneously or sequentially expand. In addition, after the pressing process ends, the upper pressing plate 32 may move upward, and simultaneously, the first diaphragm 33 and the second diaphragm 36 may expand together.

While the embodiments have been described above, the embodiments are just illustrative and not intended to limit the present invention. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and alterations are included in the scope of the present invention defined by the appended claims.

1. A stacking apparatus comprising:
a stacking module comprising a main stage, and a stacking head configured to stack a positive electrode plate, a negative electrode plate, and a separator on the main stage;
a positive electrode plate supply module configured to supply the positive electrode plate; and
a negative electrode plate supply module configured to supply the negative electrode plate,
wherein the positive electrode plate supply module and the negative electrode plate supply module each comprise:
an accommodation unit configured to accommodate an electrode plate that is any one of a plurality of positive electrode plates or a plurality of negative electrode plates; and
a pick-up unit configured to pick up the electrode plate accommodated in the accommodation unit, and
wherein the pick-up unit comprises:
a plurality of first sucking parts configured to suck the electrode plate;
a body part configured to support the plurality of first sucking parts; and
a vibration part configured to shake the picked-up electrode plate.

2. The stacking apparatus of claim 1, wherein the vibration part comprises:
a sub-block disposed to be spaced apart from the body part;
at least one second sucking part disposed on the sub-block; and
a block driving part configured to operate the sub-block.

3. The stacking apparatus of claim 2, wherein the block driving part provides vibration to the electrode plate by changing an interval between the sub-block and the body part.

4. The stacking apparatus of claim 2, wherein the block driving part provides vibration to the electrode plate by operating the sub-block upward or downward.

5. The stacking apparatus of claim 2, wherein the block driving part rotates the sub-block, and the electrode plate is warped between a region sucked by the first sucking part and a region sucked by the second sucking part as the sub-block rotates.

6. The stacking apparatus of claim 3, comprising:
an elastic member disposed between the sub-block and the block driving part.

7. The stacking apparatus of claim 2, wherein the sub-block comprises:
a first sub-block disposed at one side based on a longitudinal direction of the body part; and
a second sub-block disposed at the other side.

8. The stacking apparatus of claim 1, wherein the body part comprises:
a first body part on which the plurality of first sucking parts are disposed; and
a second body part on which the plurality of first sucking parts are disposed, and
wherein the vibration part rotates the first body part and the second body part in opposite directions.

9. The stacking apparatus of claim 1, comprising:
an eddy current sensor disposed on the body part.

10. The stacking apparatus of claim 1, further comprising:
a spray unit configured to spray air to the first accommodation unit.

11. The stacking apparatus of claim 1, wherein the stacking head rotates in a first rotation direction and picks up the positive electrode plate provided by the positive electrode plate supply module, and the stacking head rotates in a second rotation direction different from the first rotation direction and picks up the negative electrode plate supplied by the negative electrode plate supply module.

12. The stacking apparatus of claim 11, wherein the positive electrode plate supply module comprises:
a first accommodation unit configured to accommodate the plurality of positive electrode plates;
a first pick-up unit configured to pick up the positive electrode plate accommodated in the first accommodation unit; and
a first alignment stage configured to rotate to provide the positive electrode plate to the stacking head.

13. The stacking apparatus of claim 12, comprising:
a positive electrode plate inspection unit configured to inspect whether the positive electrode plate disposed on the first alignment stage is aligned.
